(19) United States
(12) Patent Application Publication
(10) Pub. No.: US 2008/0178199 A1
(43) Pub. Date: Jul. 24, 2008

(54) INFORMATION PROCESSING DEVICE, IMAGE PROCESSING APPARATUS, INFORMATION PROCESSING METHOD, AND STORAGE MEDIUM

(76) Inventor: Kazuhide Tanabe, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/968,438

(22) Filed: Jan. 2, 2008

(30) Foreign Application Priority Data
Jan. 15, 2007 (JP) 2007-006246

(51) Int. Cl. G06F 9/44

(52) U.S. Cl. 719/320

(57) ABSTRACT

A disclosed information processing device for processing a macro defining at least execution conditions of a data input unit, a data processing unit, and a data output unit includes a storage unit; a user interface unit configured to receive a macro registration request and a macro retrieval request; a macro registration unit configured to store the macro in the storage unit according to the macro registration request received by the user interface unit, the macro including macro condition IDs identifying macro conditions that are the execution conditions of the data input unit, the data processing unit, and the data output unit; and a macro retrieval unit configured to retrieve the macro from the storage unit according to the macro retrieval request received by the user interface unit and to execute the retrieved macro.

### BACKGROUND OF THE INVENTION

1. Field of the Invention

The present invention generally relates to an information processing device that performs a routine task by retrieving a registered macro defining a combination, an execution sequence, and execution conditions of functions of the information processing device and by executing the macro.

2. Description of the Related Art

Recent multifunction printers (MFPs) provide extra functions for improving efficiency in office work, such as an email transmission function for sending emails via a communication device (e.g. a network interface card (NIC)) and a document storage function for storing documents in a mass storage device (e.g. a hard disk), in addition to basic functions such as copying, fax transmission, scanning, and printing. One problem with such a multifunction printer is that users have to set up complex execution conditions of a function and filters (program modules or components) constituting the function on a console of the multifunction printer each time when executing the function.

Meanwhile, there are many routine tasks in an office which can be performed using a multifunction printer. Such routine tasks may be performed repeatedly even within one day. Therefore, setting up execution conditions of functions for such routine tasks imposes a great burden on users and decreases the improvement in efficiency of office work.

An image processing apparatus disclosed in patent document 1 tries to solve the above problem. The disclosed image processing apparatus provides a macro facility that makes it possible for a user to register execution conditions of a function as a macro for a routine task and to easily perform the routine task by retrieving and executing the macro.

[Patent document 1] Japanese Patent Application Publication No. 2006-059274

One disadvantage of a macro facility in a conventional image processing apparatus such as that disclosed in patent document 1 is that when a new function or a new filter is added to the image processing apparatus, it is necessary to modify the program code and data structure related to the macro facility to be able to register and retrieve execution conditions of the added function or filter as a macro. In other words, with a conventional macro facility, it is difficult to flexibly add new functions and filters.

### SUMMARY OF THE INVENTION

Embodiments of the present invention provide an information processing device, an image processing apparatus, an information processing method, and a storage medium containing program code for causing a computer to perform the information processing method that solve or reduce one or more problems caused by the limitations and disadvantages of the related art.

An embodiment of the present invention provides an information processing device for processing a macro defining at least execution conditions of a data input unit, a data processing unit, and a data output unit. The information processing device includes a storage unit; a user interface unit configured to receive a macro registration request and a macro retrieval request; a macro registration unit configured to store the macro in the storage unit according to the macro registration request received by the user interface unit, the macro including macro condition IDs identifying macro conditions that are the execution conditions of the data input unit, the data processing unit, and the data output unit; and a macro retrieval unit configured to retrieve the macro from the storage unit according to the macro retrieval request received by the user interface unit and to execute the retrieved macro.

Another embodiment of the present invention provides an information processing method in an information processing device for processing a macro defining at least execution conditions of a data input unit, a data processing unit, and a data output unit. The information processing method includes a macro registration step of storing the macro in a storage unit of the information processing device according to a macro registration request, the macro including macro condition IDs identifying macro conditions that are the execution conditions of the data input unit, the data processing unit, and the data output unit; and a macro retrieval step of retrieving the macro from the storage unit according to a macro retrieval request and executing the retrieved macro.

Still another embodiment of the present invention provides a storage medium having program code stored therein for causing a computer to function as a macro registration unit and a macro retrieval unit of an information processing device for processing a macro defining at least execution conditions of a data input unit, a data processing unit, and a data output unit. The macro registration unit is configured to store the macro in a storage unit of the information processing device according to a macro registration request received by a user interface unit of the information processing device, the macro including macro condition IDs identifying macro conditions that are the execution conditions of the data input unit, the data processing unit, and the data output unit. The macro retrieval unit is configured to retrieve the macro stored in the storage unit according to a macro retrieval request received by the user interface unit and to execute the retrieved macro.

### BRIEF DESCRIPTION OF THE DRAWINGS

FIG. 1 is a block diagram illustrating a hardware configuration of an exemplary image processing apparatus;

FIG. 2 is a drawing illustrating a software configuration of the exemplary image processing apparatus;

FIG. 3A is a drawing illustrating a pipes-and-filters architecture and FIG. 3B is a table showing constituent elements of a filter;

FIG. 4 is a flowchart showing a first part of a basic process in the exemplary image processing apparatus;

FIG. 5 is a flowchart showing a second part of the basic process in the exemplary image processing apparatus;

FIG. 6 is a drawing illustrating constituent elements of an exemplary routine task;

FIG. 7 is a drawing illustrating screens used in an exemplary macro registration process;

FIG. 8 is a drawing illustrating another screen used in the exemplary macro registration process;

FIG. 9 is a class diagram illustrating relationships between information items constituting a macro;

FIG. 10 is a table showing contents of exemplary information items constituting a macro;

FIG. 11 is a drawing illustrating exemplary macro configuration information in the middle of a registration process;

FIG. 12 is a table showing information items of a registered macro;

FIG. 13 is a drawing illustrating screens used in an exemplary process of retrieving a registered macro;

FIG. 14 is a drawing illustrating an exemplary relational structure of modules constituting a component;

FIG. 15 is a drawing illustrating components involved in a macro registration process;

FIG. 16 is a drawing illustrating components involved in a macro retrieval process;

FIG. 17 is a block diagram illustrating a hardware configuration of an exemplary information processing device;

FIG. 18 is a block diagram illustrating functional units involved in a macro registration process;

FIG. 19 is a drawing illustrating how information items of a macro are structured;

FIG. 20 is a block diagram illustrating functional units involved in a macro retrieval process;

FIG. 21 is a flowchart showing an exemplary macro registration process;

FIG. 22 is a flowchart showing an exemplary macro retrieval process;

FIG. 23 is a sequence chart showing interactions between components in a process of registering a multi-activity macro;

FIG. 24 is a sequence chart showing interactions between components in a process of registering a single-activity macro;

FIG. 25A is a sequence chart showing interactions between components in a process of registering a macro for document processing;

FIG. 25B is a table showing exemplary macro configuration information;

FIG. 26A is a sequence chart showing interactions between components in a process of registering a macro for data processing;

FIG. 26B is a table showing exemplary macro configuration information;

FIG. 27 is a sequence chart showing interactions between components in a first part of an exemplary macro retrieval process;

FIG. 28 is a sequence chart showing interactions between components in a second part of the exemplary macro retrieval process; and

FIG. 29 is a sequence chart showing interactions between components in a third part of the exemplary macro retrieval process.

### DESCRIPTION OF THE PREFERRED EMBODIMENTS

Preferred embodiments of the present invention are described below with reference to the accompanying drawings.

### <Hardware Configuration of Image Processing Apparatus>

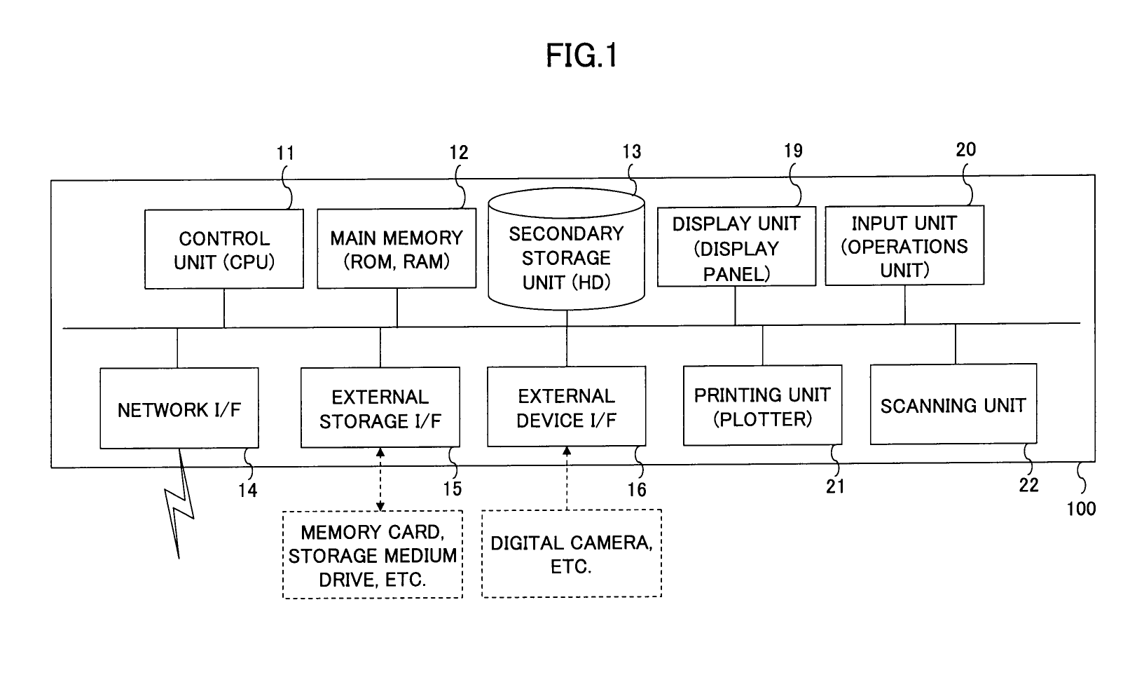

An exemplary hardware configuration of an image processing apparatus according to an embodiment of the present invention is described below with reference to FIG. 1.

FIG. 1 is a block diagram illustrating a hardware configuration of an image processing apparatus 100 according to an embodiment of the present invention.

As shown in FIG. 1, the image processing apparatus 100 includes a control unit (central processing unit: CPU) 11, a main memory (read-only memory (ROM) and/or random-access memory (RAM)) 12, a secondary storage unit (hard disk) 13, a network I/F 14, an external storage I/F 15, an external device I/F 16, a display unit (display panel) 19, an input unit (operations unit) 20, a printing unit (plotter) 21, and a scanning unit 22.

The control unit 11 controls other units in the image processing apparatus 100 and performs arithmetic operations and data processing. More specifically, the control unit 11 executes programs stored in the main memory 12, thereby processes data received from an input device or a storage device, and outputs the processed data to an output device or a storage device.

The main memory 12 stores programs to be executed and data to be processed by the control unit 11.

The secondary storage unit 13 stores an operating system (OS) used as basic software and application programs together with accompanying data. The secondary storage unit 13 also stores various types of information managed as databases or files by the image processing apparatus 100.

The network I/F 14 interfaces the image processing apparatus 100 and other devices having communication facilities and connected to a network, such as a local area network (LAN) or a wide area network (WAN), implemented by wired and/or wireless data transmission channels.

The external storage I/F 15 interfaces the image processing apparatus 100 and an external storage device (e.g. a storage medium drive) connected via a data transmission line such as a universal serial bus (USB).

The external device I/F 16 interfaces the image processing apparatus 100 and an external input device (e.g. a digital camera) connected via a data transmission line such as a USB.

The image processing apparatus 100 sends/receives or writes/reads data to/from external devices via the above interfaces.

The display unit 19 and the input unit 20 function as a user interface (UI), and are implemented by a liquid crystal display (LCD) equipped with keys (including hard keys and soft keys of a graphical user interface) and a touch panel.

The printing unit 21 forms (or prints) an image on a recording medium (e.g. paper) according to CMYK image data by an electrophotographic process (including exposure, latent image forming, developing, and transfer steps) using a laser beam.

The scanning unit 22 includes a line sensor comprising a charge coupled device (CCD), an A/D converter, and a driving circuit for driving the line sensor and the A/D converter. The scanning unit 22 scans a document placed on a document scanning surface (contact glass) and thereby obtains digital image data (with 8 bits per pixel for each of RGB components) of the document.

Thus, the image processing apparatus 100 provides functions, such as copying, fax transmission, scanning, and printing, by executing programs stored in the main memory 12 and the secondary storage unit 13 and thereby controlling its constituent hardware units.

<Software configuration of Image Processing Apparatus and Basic Process>

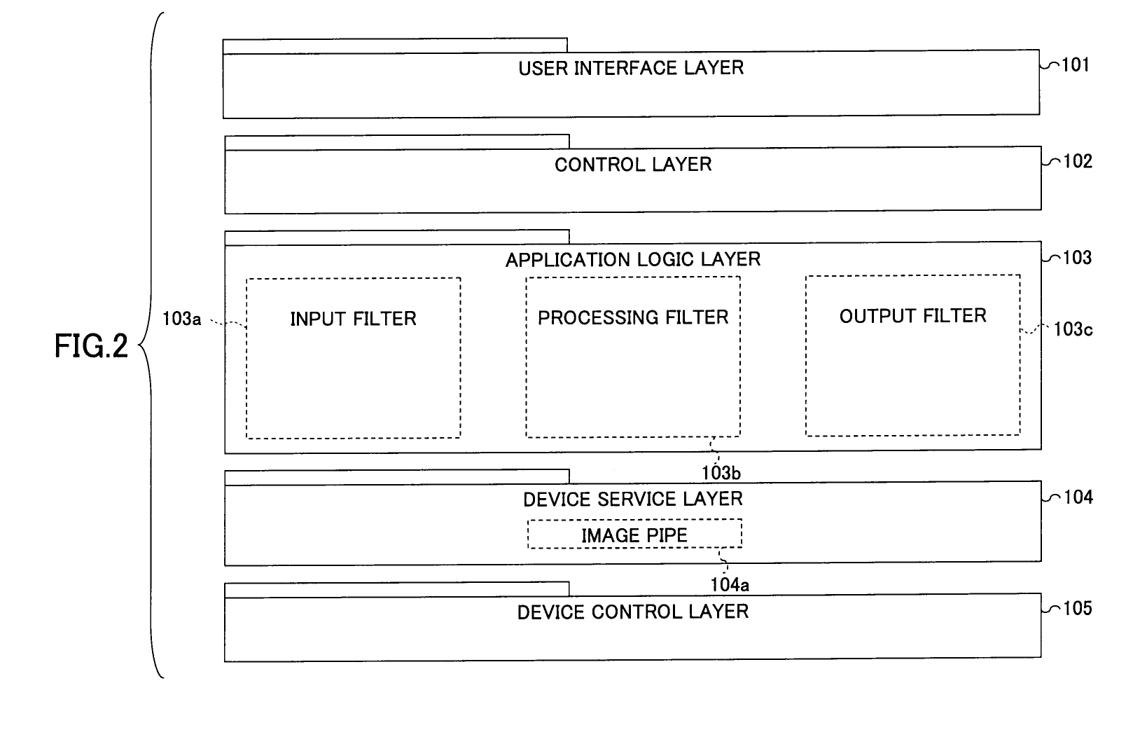

An exemplary software configuration of the image processing apparatus 100 and an exemplary basic process in the image processing apparatus 100 are described below with reference to FIGS. 2 through 5.

FIG. 2 is a drawing illustrating an exemplary software configuration of the image processing apparatus 100.

As shown in FIG. 2, the image processing apparatus 100 includes a user interface layer 101, a control layer 102, an application logic layer 103, a device service layer 104, and a device control layer 105. In FIG. 2, layers are arranged in a hierarchical order where a higher layer calls a lower layer.

The user interface layer 101 includes interfaces that receive execution requests to execute functions such as copying, fax transmission, scanning, and printing. For example, the user interface layer 101 includes a communication server for receiving requests from a user terminal (not shown) via a network and a local user interface (UI) unit for receiving requests input via the display unit 19 and the input unit 20. Requests received by the user interface layer 101 are forwarded to the control layer 102.

The control layer 102 includes units for controlling processes of requested functions. More specifically, the control layer 102 connects software parts in the application logic layer 103 according to a requested function and controls execution of the software parts. In this embodiment, a “function” of the image processing apparatus 100 indicates a piece of software or an application executed by the image forming apparatus 100 to provide a particular service (sequence of processes from input of a request to output of the result) for the user.

The application logic layer 103 includes software parts that constitute functions. In other words, in the image processing apparatus 100, a function is implemented by a combination of software parts in the application logic layer 103. Those software parts are called “filters” in a software architecture called “pipes-and-filters” of this embodiment.

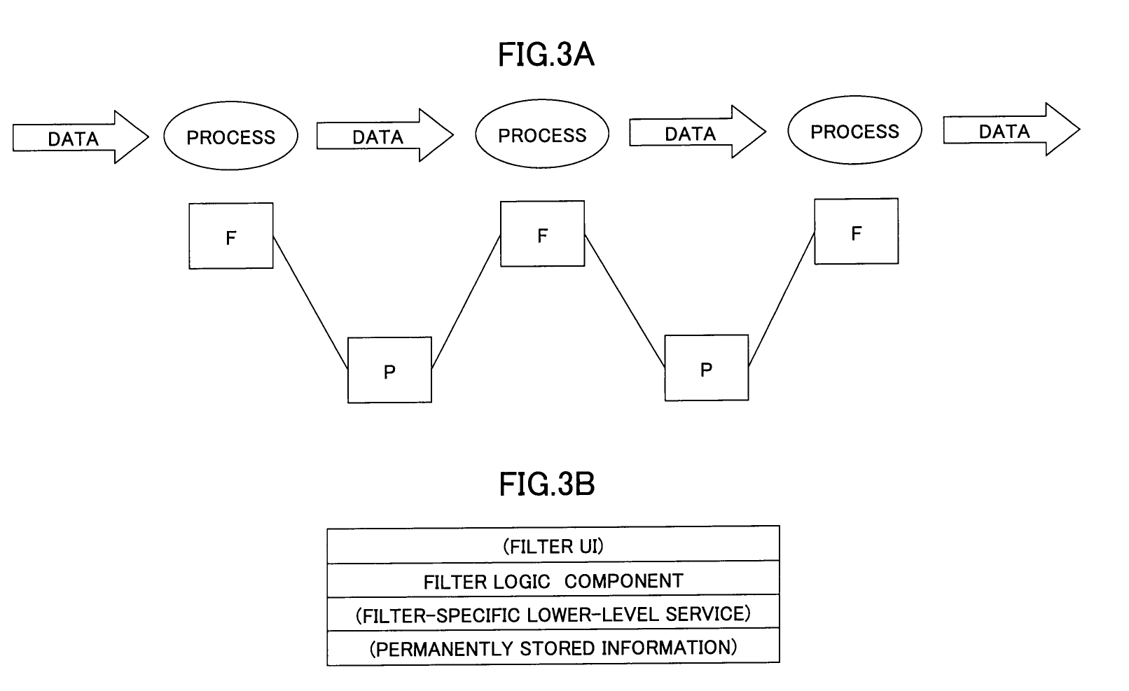

FIG. 3A is a drawing illustrating a pipes-and-filters architecture and FIG. 3B is a table showing constituent elements of a filter according to an embodiment of the present invention.

In FIG. 3A, “F” indicates a filter and “P” indicates a pipe. As shown in FIG. 3A, filters are connected by pipes. Each filter processes input data and outputs the result. Each pipe passes data output from a preceding filter to a subsequent filter. In other words, in the image processing apparatus 100 of this embodiment, the task of a function is implemented by a series of processes performed by filters on information such as user information or document data managed in the image processing apparatus 100. In a sense, each function of the image processing apparatus 100 is a combination of input, processing, and output processes. Each of the input, processing, and output processes is implemented by a software part (program module or component) called “filter”. An “input filter” inputs data, a “processing filter” performs processing on the input data, and an “output filter” outputs the processed data. Filters are basically independent from each other, i.e., there is no dependency between filters. Therefore, it is basically possible to add (install) and delete (uninstall) filters without taking into account their dependency.

Referring back to FIG. 2, the application logic layer 103 includes input filters 103a, processing filters 103b, and output filters 103c. The input filters 103a include a scanning filter for controlling scanning of an image by the scanning unit 22 and outputting the scanned image data; a stored document retrieving filter for retrieving document data (image data) stored in the secondary storage unit 13 and outputting the retrieved document data; an email reception filter for receiving an email message and outputting data in the received email message; a fax reception filter for receiving a fax message and outputting data in the fax message; a PC document reception filter for receiving print data from a user terminal (PC) and outputting the received print data; and a report filter for retrieving setting information and history information of the image processing apparatus 100 and outputting the information in a tabular format.

The processing filters 103b include a document processing filter for performing image processing such as N-up processing or resizing on input data and outputting the processed data; and a document conversion filter for converting (rendering) input PostScript data into bitmap data and outputting the bitmap data.

The output filters 103c include a printing filter for causing the printing unit 21 to output (print) input data; a document storage filter for storing input data in the secondary storage unit 13; an email transmission filter for attaching input data to an email message and sending the email message; a fax transmission filter for sending input data as a fax message; a PC document transmission filter for sending input data to a user terminal (PC); and a preview filter for displaying input data as a preview on the display unit 19.

The device service layer 104 includes lower-level functions commonly used by filters in the application logic layer 103. For example, the device service layer 104 includes an image pipe 104a for passing output data from a preceding filter to a subsequent filter, and a data management unit representing databases such as a user information database and a document database.

The device control layer 105 includes program modules called drivers for controlling hardware devices. For example, the device control layer 105 includes a scanner control unit, a plotter control unit, a memory control unit, a telephone line control unit, and a network control unit for controlling respective devices indicated by their names.

As shown in FIG. 3B, a filter includes a filter UI, a filter logic component, a filter-specific lower-level service, and permanently stored information. The filter UI, the filter-specific lower-level service, and the permanently stored information are optional elements.

The filter UI is a program for displaying a screen for setting execution conditions of the filter on a display such as the display unit 19. For example, the filter UI of the scanning filter displays a screen for setting a resolution, a density, and an image type. The filter UI may be implemented as hypertext markup language (HTML) data or scripting language data for displaying a screen on the display unit 19.

A filter logic component is a program for performing the task of a filter. A filter logic component performs the task of a filter by using a filter-specific lower-level service of the filter, a lower-level function in the device service layer 104, and/or a driver in the device control layer 105 according to execution conditions specified via the filter UI. For example, the filter logic component of the scanning filter controls the scanning unit 22 to scan an image.

A filter-specific lower-level service is a library used by the filter logic component. A filter-specific lower-level service is similar to a lower-level function in the device service layer 104 or a driver in the device control layer 105, but is implemented as a part of a filter since it is used only by the filter. For example, the scanning filter can perform its task using the scanner control unit in the device control layer 105 and therefore does not require a filter-specific lower-level service.

The permanently stored information is default setting information (e.g. default execution conditions) or a schema of a filter stored in a non-volatile memory. A schema of a filter is registered in the data management unit when the filter is installed.

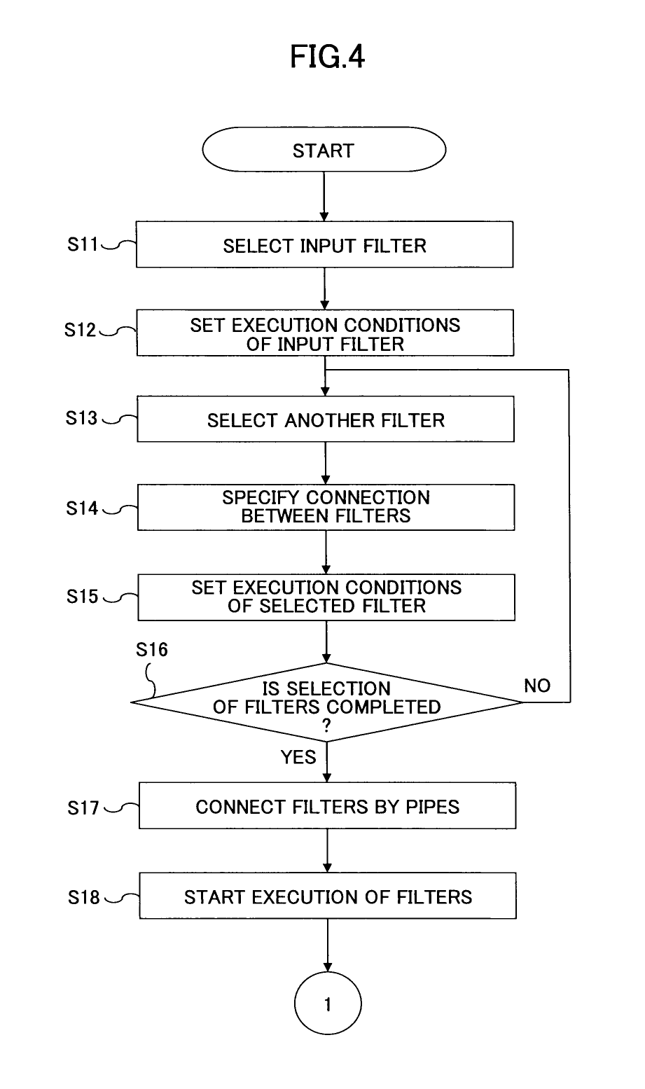

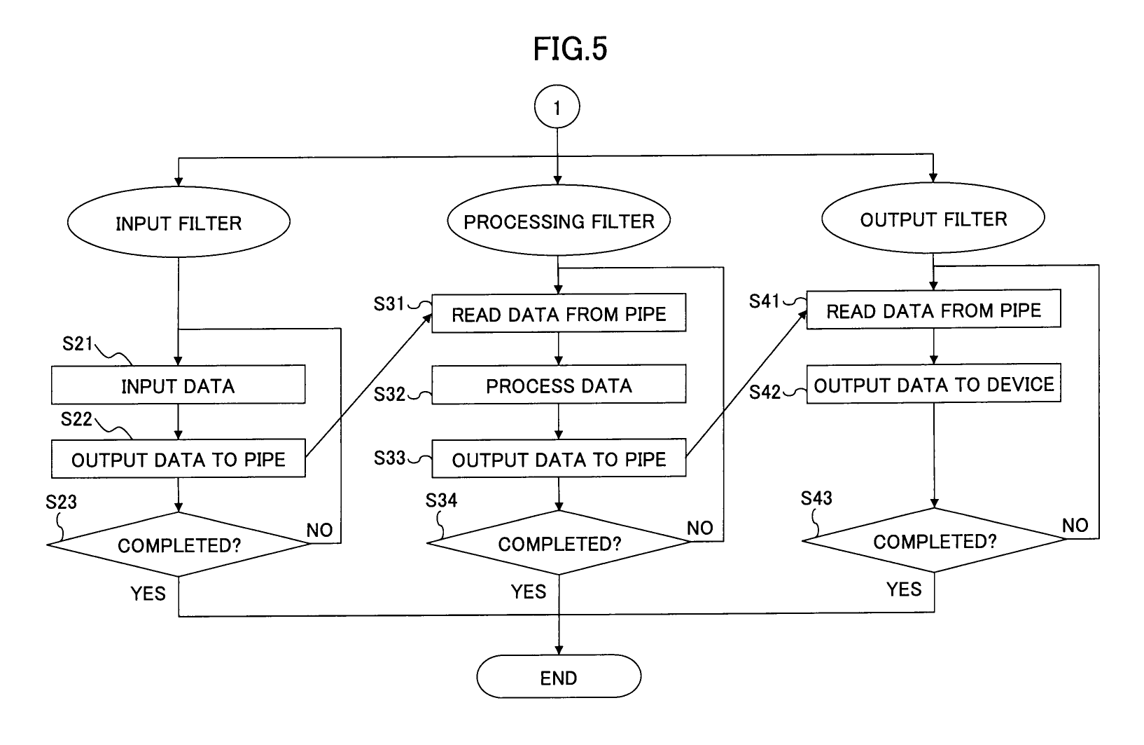

An exemplary basic process in the image processing apparatus 100 is described below with reference to FIGS. 4 and 5.

FIGS. 4 and 5 are flowcharts showing an exemplary basic process in the image processing apparatus 100 according to an embodiment of the present invention. Here, a basic process indicates a common process performed by the image processing apparatus 100 when a given function is executed.

As shown in FIG. 4, the user selects an input filter (S11) and sets execution conditions of the selected input filter (S12). Similarly, the user selects a processing filter and an output filter (S13), specifies connection between the filters (S14), and sets execution conditions of the filters (S15).

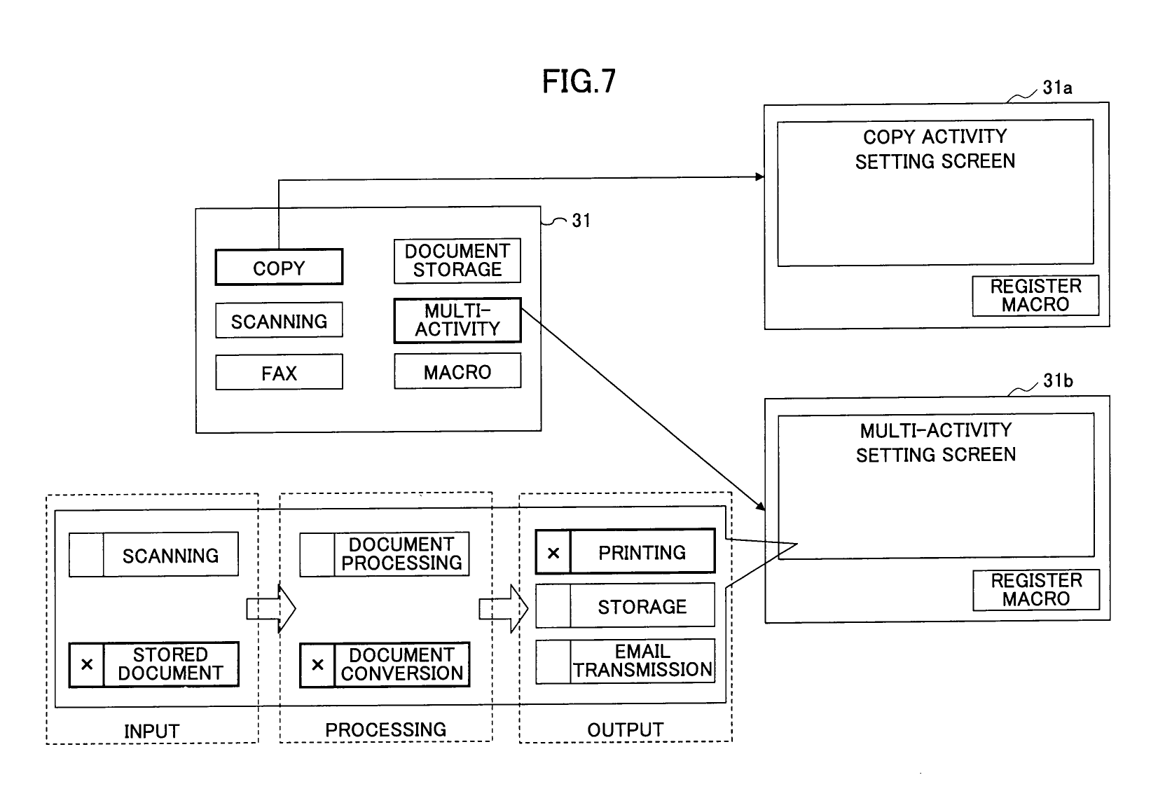

The above steps are performed under the control of the local UI unit of the user interface layer 101 using a screen like a multi-activity setting screen 31b shown in FIG. 7. The exemplary screen shown in FIG. 7 includes input, processing, and output areas for selecting input, processing, and output filters. Each area includes software keys representing filters. For example, as shown in FIG. 7, the input area includes software keys representing a scanning filter and a stored document retrieving filter, the processing area includes software keys representing a document processing filter and a document conversion filter, and the output area includes software keys representing a printing filter, a storage filter, and an email transmission filter.

In each area, the user can select two or more filters. In other words, a function may include two or more of the input filters 103a, two or more of the processing filters 103b, and two or more of the output filters 103c. For example, a function for printing converted document data and also sending the document data as an email message includes the printing filter and the email transmission filter as output filters.

Referring back to FIG. 4, when selection of filters is completed (YES in step S16) and a start button is pressed, the user interface layer 101 sends information on the requested function (e.g. names of selected filters and settings for the filters) to the control layer 102.

The control layer 102 connects the selected filters by pipes according to the information on the requested function sent from the user interface layer 101 (S17). A pipe is implemented by a memory (including the secondary storage unit 13). Different types of memories are used as pipes depending on types of filters at both ends of respective pipes. The correspondence between the types of memories and the types of filters is predefined in the secondary storage unit 13 of the image processing apparatus 100. The control layer 102 connects filters by appropriate pipes according to the predefined correspondence. After step S17, the control layer 102 sends execution requests in parallel to the filters constituting the function (S18). In other words, filters in a function are not called in the order of connection, but are called at substantially the same time. This is possible because filters are synchronized by pipes. When receiving an execution request from the control layer 102, a filter waits until data are input to its input-side pipe. As an exception, no pipe is provided at the input-side of an input filter 103a. An input filter 103a starts a process as soon as it receives an execution request.

In FIG. 5, the input filter 103a inputs data from an input device (S21) and outputs the input data to a pipe connected to its output side (S22). If data are input in multiple sessions (e.g. when inputting scanned data of a document having multiple pages), steps S21 and S22 are repeated. After inputting all data (YES in step S23), the input filter 103a terminates its process.

The processing filter 103b starts a process when detecting input of data to its input-side pipe. The processing filter 103b reads the input data from the input-side pipe (S31), performs image processing on the input data (S32), and outputs the processed data to its output-side pipe (S33). After processing all input data (YES in step S34), the processing filter 103b terminates its process.

The output filter 103c starts a process when detecting input of data to its input-side pipe. The output filter 103c reads the input data from the input-side pipe (S41) and outputs the input data to an output device (S42). After outputting all input data (YES in step S43), the output filter 103c terminates its process.

### <Constituent Elements of Routine Task>

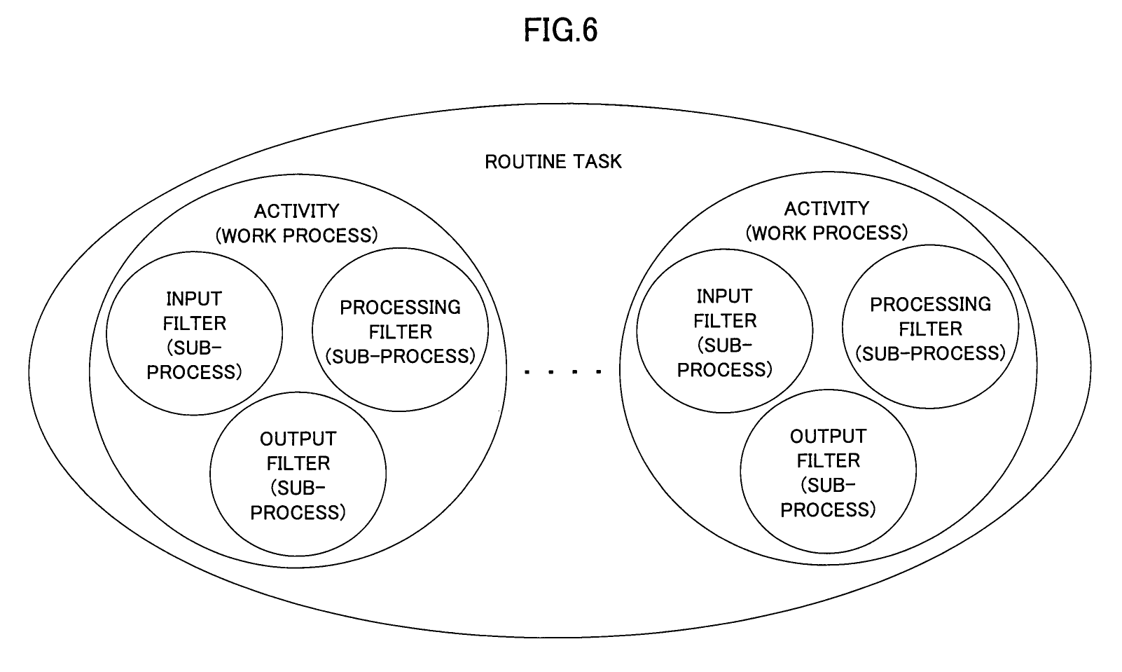

Exemplary elements constituting a routine task performed by using a function(s), such as copying, fax transmission, scanning, and printing, of the image processing apparatus 100 are described below with reference to FIG. 6 based on the pipes-and-filters architecture and the basic process mentioned above.

FIG. 6 is a drawing illustrating constituent elements of an exemplary routine task according to an embodiment of the present invention.

Normally, a routine task includes one or more work processes each including one or more sub-processes performed in a predetermined sequence. In this embodiment, work processes are represented by activities that correspond to functions of the image processing apparatus 100, and sub-processes are represented by filters. For example, the copying function (or the copy activity) of the image processing apparatus 100 represents a work process, and the scanning, document processing, and printing filters of the copying function represent sub-processes. An exemplary routine task for scanning a document and printing and faxing the scanned document may include two activities: the copying function (activity) and the fax transmission function (activity).

Thus, as shown in FIG. 6, a routine task is composed of one or more activities (work processes) and each activity is composed of one or more filters (sub-processes).

In other words, in the pipes-and-filters architecture, input, processing, and output sub-processes constituting a work process (activity) in a routine task are implemented by input, processing, and output filters.

According to an embodiment of the present invention, a routine task can be registered in the image processing apparatus 100 as a macro defining a combination, an execution sequence, and execution conditions of activities and filters constituting the routine task. A user can perform a routine task by retrieving and executing the corresponding macro.

### <Registration of Macro>

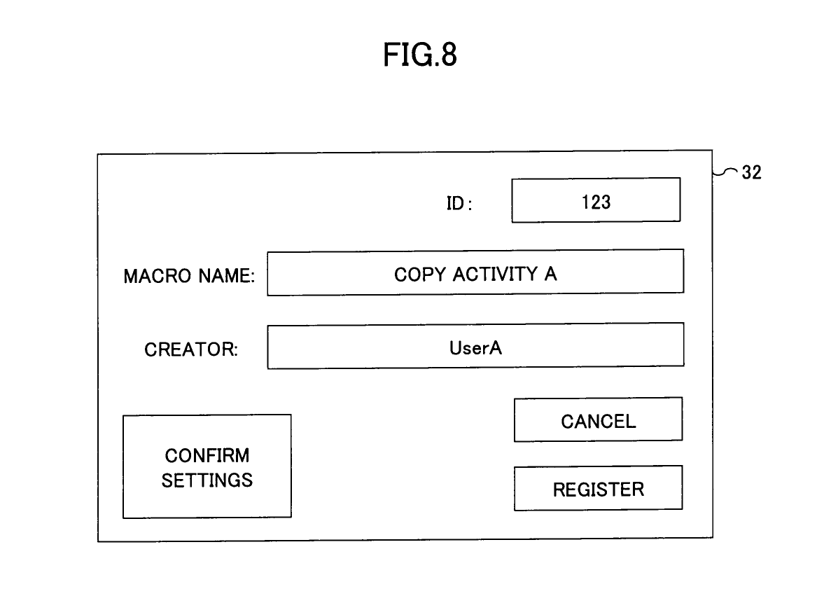

An exemplary process of registering a macro is described below with reference to FIGS. 7 and 8.

FIG. 7 is a drawing illustrating screens used in an exemplary macro registration process according to an embodiment of the present invention.

A macro registration process varies depending on the routine task to be implemented by a macro. As shown in FIG. 7, when registering a macro for a routine task involving only one preset function (i.e. a preset combination of filters) of the image processing apparatus 100 (such a macro is hereafter called a single-activity macro), the user selects, for example, the copying function by pressing a Copy button on an application selection screen 31 displayed on the display unit 19. Then, a copy activity setting screen 31a is displayed to request the user to specify execution conditions for the copying function (copy activity). On the other hand, when registering a macro for a routine task involving multiple functions or activities (i.e. any given combination of filters) of the image processing apparatus 100 (an activity constituting such a macro is hereafter called a multi-activity, and such a macro is hereafter called a multi-activity macro), the user presses a Multi-Activity button on the application selection screen 31 displayed on the display unit 19. Then, the multi-activity setting screen 31b is displayed to request the user to select filters corresponding to input, processing, and output sub-processes in the routine task and to specify execution conditions for the multi-activity and the selected filters (on the exemplary screen shown in FIG. 7, the stored document retrieving filter, the document conversion filter, and the printing filter are selected). Thus, as a first step of a macro registration process, an activity or filters are selected and execution conditions of each of the activity and filters are specified.

Next, when the user presses a Register Macro button on the copy activity setting screen 31a or the multi-activity setting screen 31b, a macro parameter setting screen 32 is displayed on the display unit 19 as shown in FIG. 8.

The user enters a macro ID, a macro name, and a creator and presses a Register button on the macro parameter setting screen 32 to register the macro. Pressing a Confirm Settings button on the macro parameter setting screen 32 enables the user to confirm the execution conditions of the activity and filters in the macro to be registered.

### <Details of Macro>

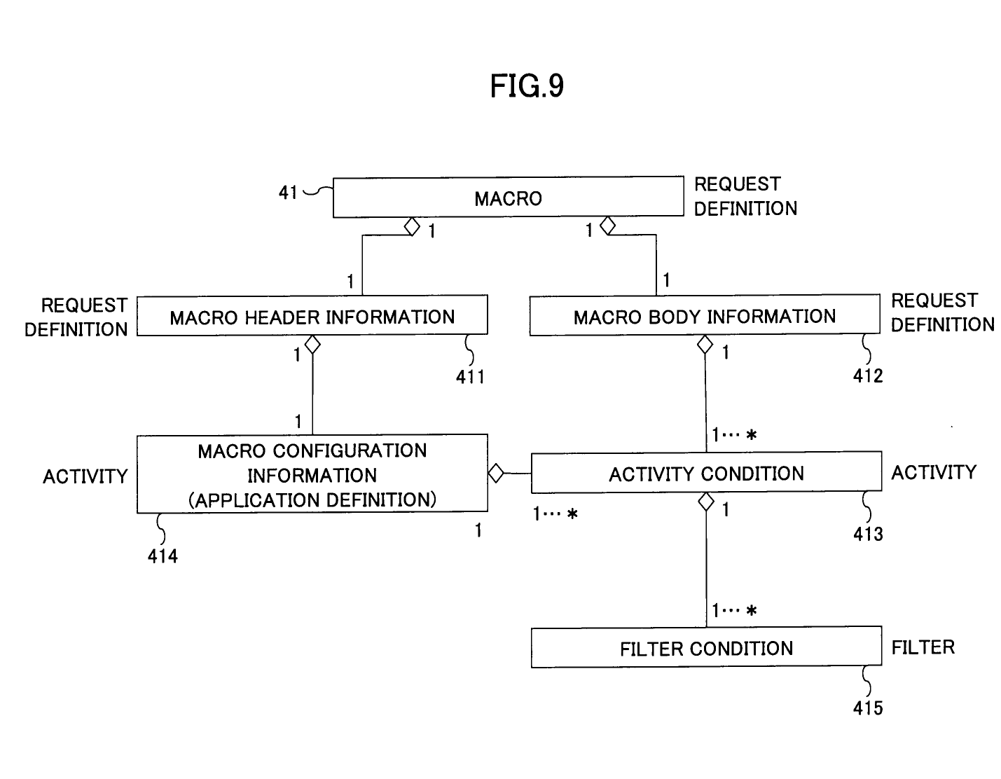

Details of a macro are described below with reference to FIGS. 9 through 12.

FIG. 9 is a class diagram illustrating relationships between information items constituting a macro 41 according to an embodiment of the present invention.

As shown in FIG. 9, the macro 41 includes macro header information 411 and macro body information 412. The macro header information 411 includes macro configuration information 414. The macro body information 412 includes one or more activity conditions 413 (conditions of work processes) and each activity condition 413 includes one or more filter conditions 415 (conditions of sub-processes). The macro configuration information 414 also includes one or more activity conditions 413.

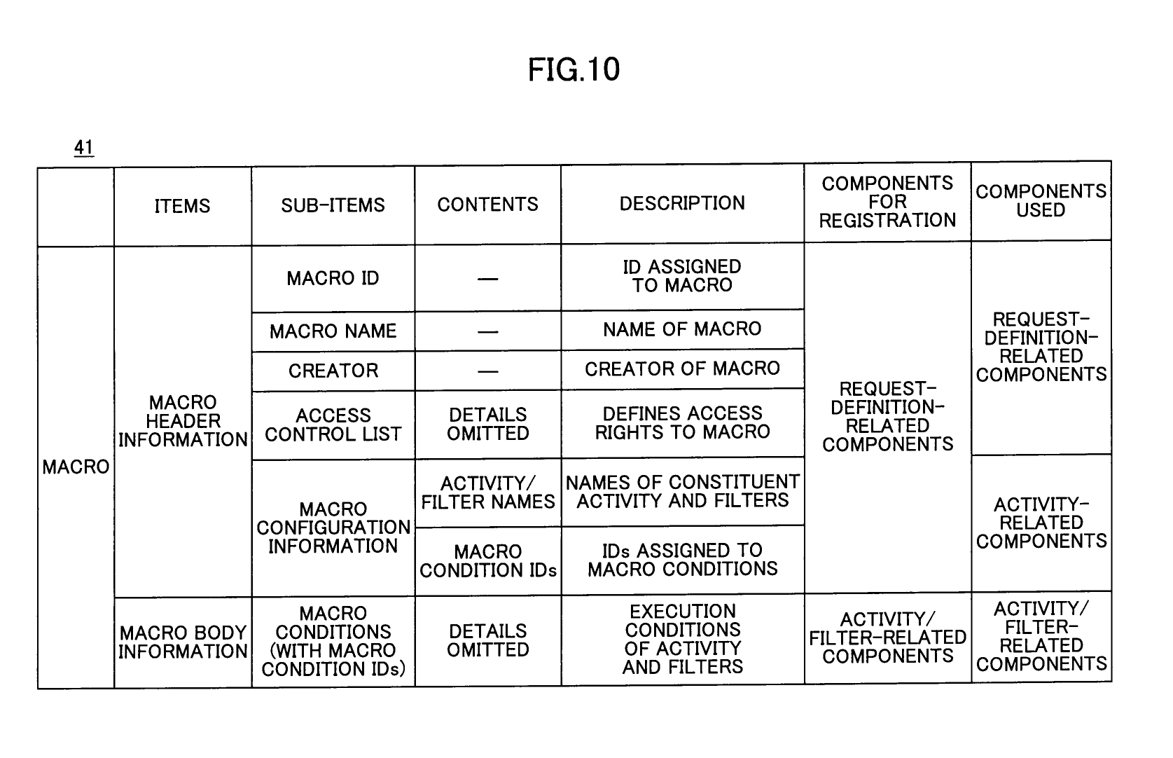

FIG. 10 is a table showing contents of the information items constituting the macro 41.

The macro header information 411 includes a macro ID for identifying the macro 41, a macro name of the macro 41, a creator of the macro 41, an access control list defining access rights to the macro 41, and the macro configuration information 414 regarding an activity (or activities) and filters constituting the macro 41.

The macro configuration information 414 includes activity and filter names of the constituent activity and filters, and macro condition IDs (condition identification information) for identifying macro conditions that are execution conditions of the constituent activities and filters.

The macro body information 412 includes macro conditions that are execution conditions of the constituent activity and filters.

The macro ID, the macro name, and the creator are entered on the macro parameter setting screen 32 shown in FIG. 8. The activity and filter names and the macro conditions are specified on the copy activity setting screen 31a (or a screen for specifying execution conditions of any given activity) or the multi-activity setting screen 31b shown in FIG. 7.

Thus, the macro ID, the macro name, the creator, the activity and filter names, and the macro conditions shown in FIG. 10 are specified by the user on user interfaces displayed on the display unit 19.

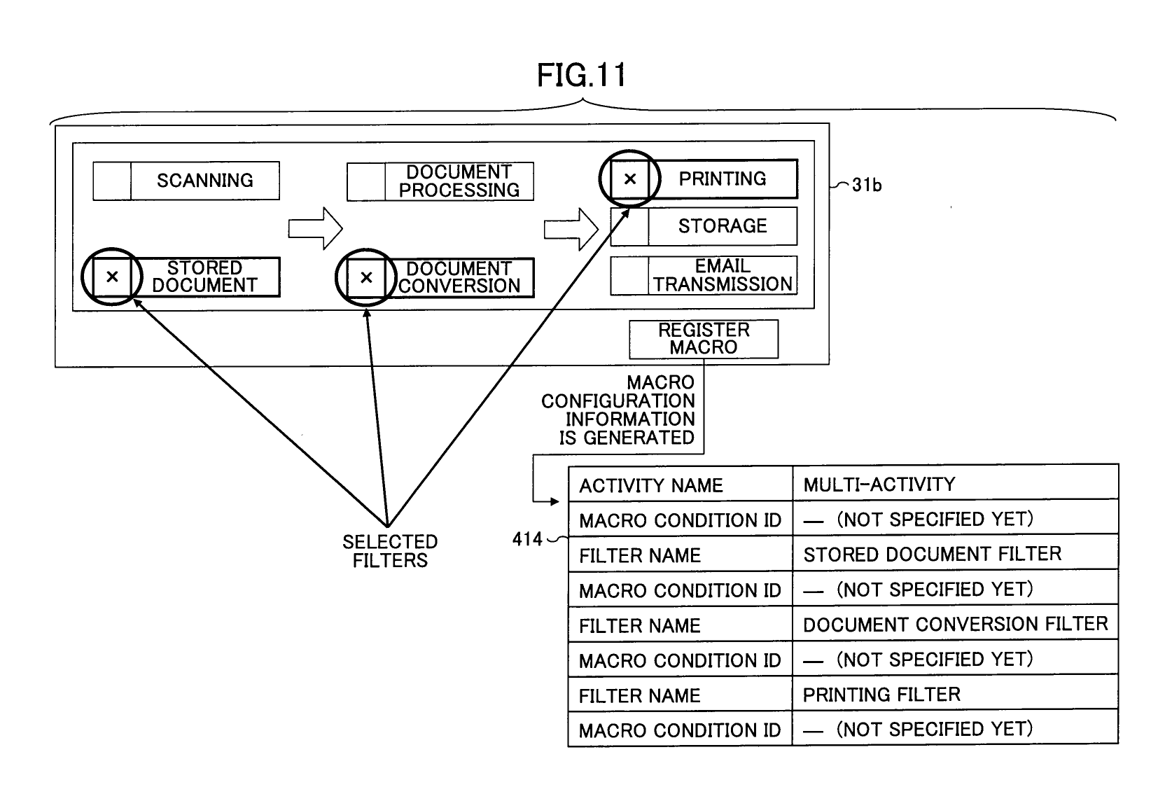

For example, if the user selects the stored document retrieving filter, the document conversion filter, and the printing filter and presses the Register Macro button on the multi-activity setting screen 31b, the macro configuration information 414 as shown in FIG. 11 is generated. In the macro configuration information 414 shown in FIG. 11, the activity and filter names are specified, but the macro condition IDs corresponding to the activity and filter names are not specified yet.

The macro condition IDs are automatically set in the macro configuration information 414 when the user presses the Register button on the macro parameter setting screen 32 shown in FIG. 8.

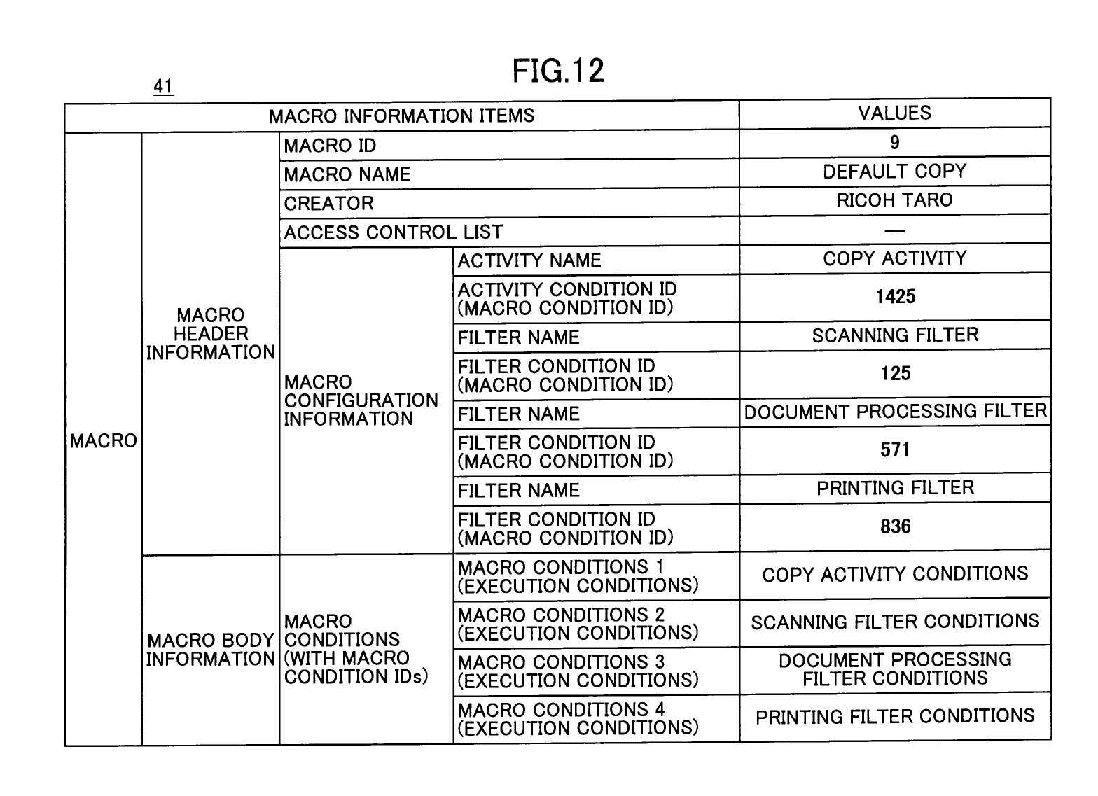

For example, when the user presses the Register button, the macro 41 with macro condition IDs set is registered in the image processing apparatus 100 as shown in FIG. 12 (bold-faced numbers indicate the macro condition IDs).

### <Retrieval of Macro>

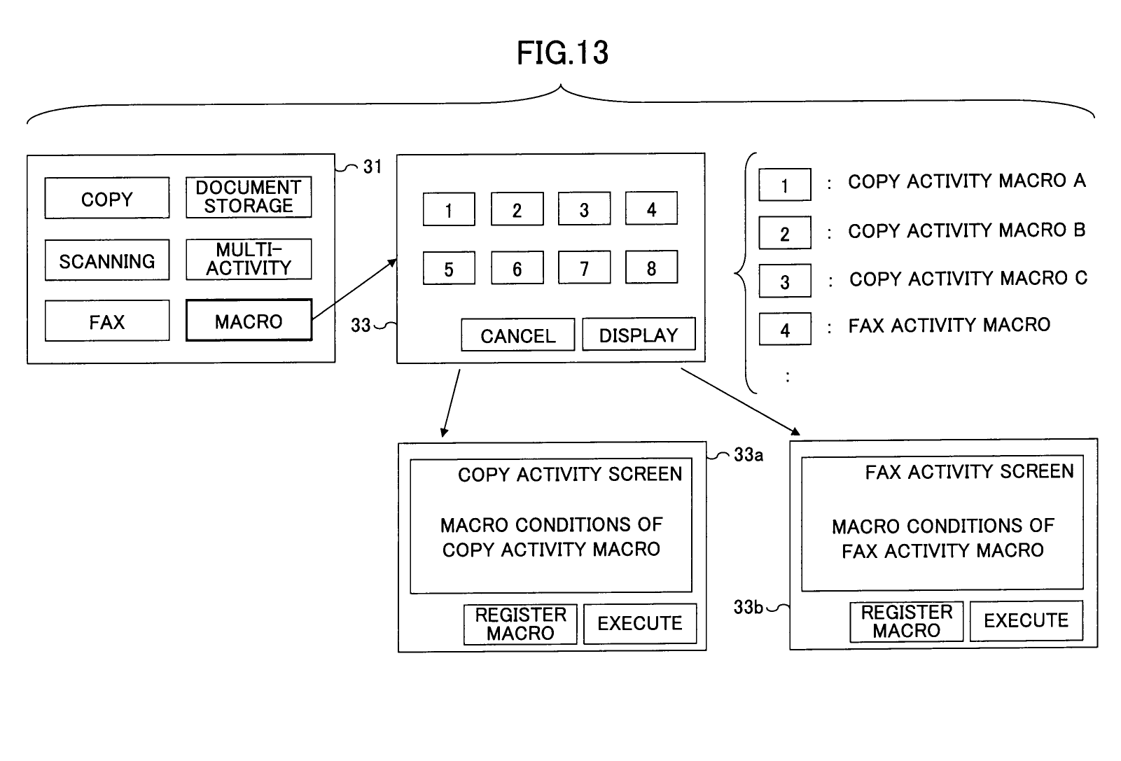

An exemplary process of retrieving a macro is described below with reference to FIG. 13.

FIG. 13 is a drawing illustrating screens used in an exemplary process of retrieving a registered macro according to an embodiment of the present invention.

As shown in FIG. 13, when the user presses a Macro button on the application selection screen 31, a macro list screen 33 is displayed on the display unit 19. The user can select and execute any one of registered macros displayed on the macro list screen 33. On the macro list screen 33, macro keys (short-cut keys: 1 through n) are assigned to the registered macros. In this example, macro keys 1 through 3 are assigned to copy activity macros A through C and a macro key 4 is assigned to a fax activity macro. When the user selects any one of the macro keys 1 through 3 and presses a Display button, a copy activity screen 33a showing execution conditions of a copy activity and filters constituting the copy activity macro is displayed on the display unit 19. When the user selects the macro key 4 and presses the Display button, a fax activity screen 33b showing execution conditions of a fax activity and filters constituting the fax activity macro is displayed on the display unit 19. Each of the copy activity screen 33a and the fax activity screen 33b includes a Register Macro button. When the user changes execution conditions (or macro conditions) of a macro and presses the Register Macro button, the macro conditions are updated and the macro is reregistered in the image processing apparatus 100.

Each of the copy activity screen 33a and the fax activity screen 33b includes an Execute button. When the user presses the Execute button after confirming the macro conditions of a macro, the macro is executed.

### <Components Involved in Macro Registration and Retrieval Processes>

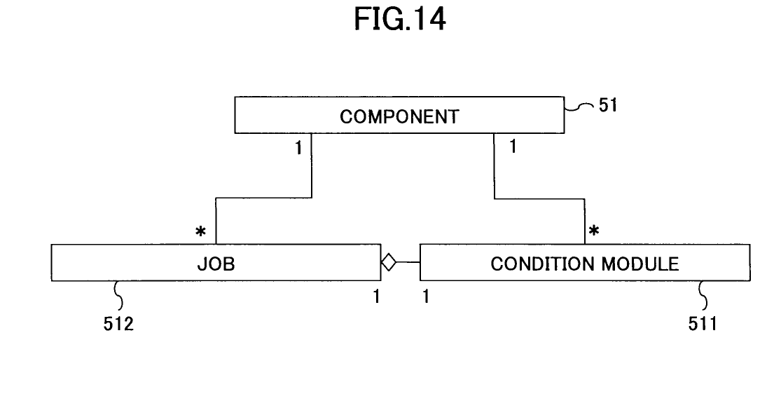

Next, components (and/or program modules) involved in macro registration and retrieval processes are described with reference to FIGS. 14 through 16. Here, a “component” indicates a functional unit composed of one or more software/data modules.

FIG. 14 is a drawing illustrating an exemplary relational structure of modules constituting a component 51 according to an embodiment of the present invention.

As shown in FIG. 14, the component 51 includes a job 512 that performs a process and a condition module 511 that specifies and retains execution conditions or parameters used when the job 512 is executed. Since the parameters retained by the condition module 511 are used when the job 512 is executed, the condition module 511 has an aggregation relationship with the job 512.

The component 51 does not necessarily include both the condition module 511 and the job 512. In other words, the component 51 may not include the condition module 511 or the job 512.

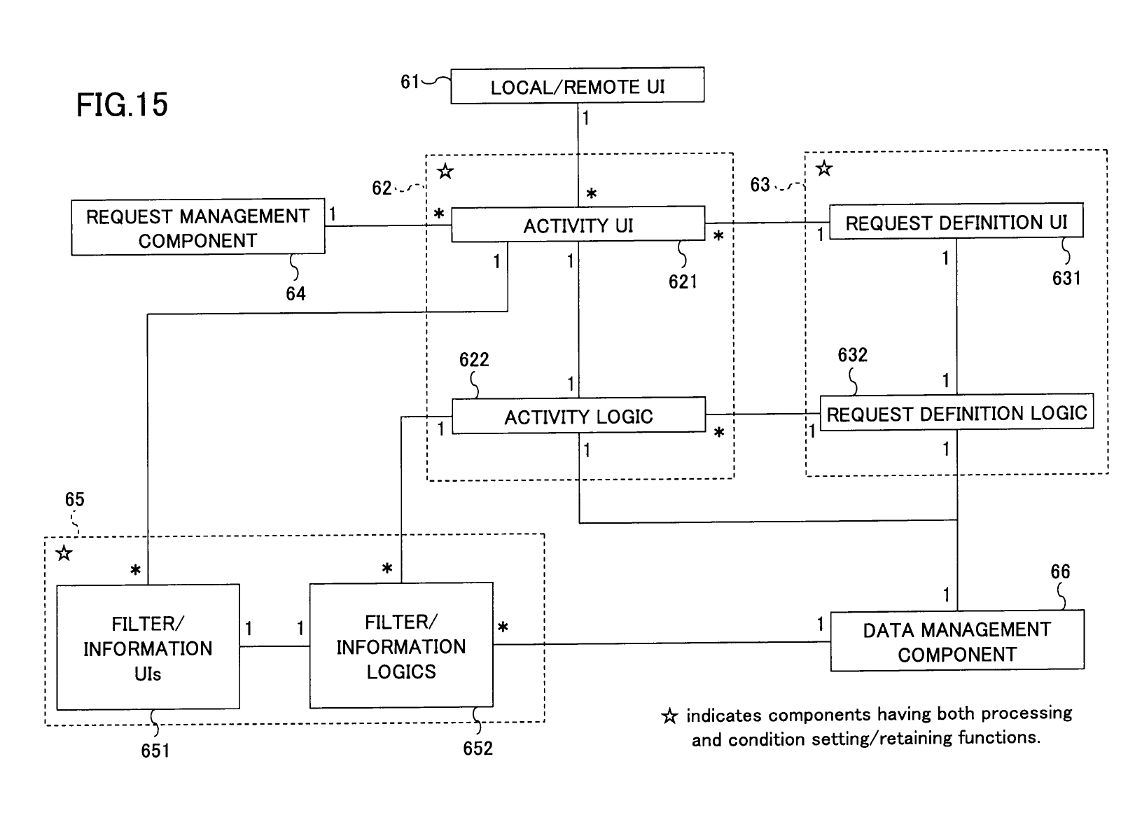

FIG. 15 is a drawing illustrating components involved in a macro registration process according to an embodiment of the present invention.

Components involved in a macro registration process include a local/remote UI 61, activity-related components 62, request-definition-related components 63, a request management component 64, filter/information-related components 65, and a data management component 66. The activity-related components 62 include an activity UI 621 and an activity logic component 622 for each activity. The request-definition-related components 63 include a request definition UI 631 and a request definition logic component 632. The filter/information-related components 65 include filter/information UIs (filter UIs and/or information UIs) 651 and filter/information logic components (filter logic components and/or information logic components) 652. Each component in the activity-related components 62, the request-definition-related components 63, and the filter/information-related components 65 has a structure as shown in FIG. 14.

Operations of the above components and relationships between them are described below using an exemplary macro registration process (steps 1-1 through 1-6).

(1-1) Receiving Macro Registration Request

When a user presses one of the buttons (other than the Macro button) on the application selection screen 31 shown in FIG. 7, the corresponding macro registration request is sent to the local/remote UI 61. When receiving the macro registration request, the local/remote UI 61 requests the activity UI 621 to generate a next screen (user interface). The activity UI 621 generates an activity setting screen (macro condition setting screen), such as the copy activity setting screen 31a or the multi-activity setting screen 31b shown in FIG. 7, for entering execution conditions of an activity and its constituent filters according to the request from the local/remote UI 61, and displays the activity setting screen on the display unit 19. More specifically, the activity UI 621 requests the request definition UI 631 to generate parts (or constituent elements) of the activity setting screen and generates the activity setting screen from the parts generated by the request definition UI 631.

(1-2) Setting Execution Conditions of Activity and Filters

The activity UI 621 receives execution conditions entered on the activity setting screen and when a Register Macro button on the activity setting screen is pressed, sends the received execution conditions to the activity logic component 622 and the filter/information logic components 652.

The activity logic component 622 stores execution conditions of its activity, which are sent from the activity UI 621, in an area of a RAM reserved by itself. Each of the filter/information logic components 652 stores execution conditions of the corresponding filter, which are sent from the activity UI 621, in an area of a RAM reserved by itself.

(1-3) Setting Macro Parameters

When the Register Macro button is pressed on the activity setting screen generated by the activity UI 621, the local/remote UI 61 generates a macro parameter setting screen, like the macro parameter setting screen 32 shown in FIG. 8, for entering macro parameters including a macro ID, a macro name, and a creator, and displays the generated macro parameter setting screen on the display unit 19. The local/remote UI 61 receives macro parameters entered on the macro parameter setting screen and sends the received macro parameters to the request definition UI 631.

Based on the macro parameters, the request definition UI 631 requests the request definition logic component 632 to set the macro ID, the macro name, and the creator in the macro header information 411 of the macro 41.

(1-4) Requesting Registration of Macro

When a Register button on the macro parameter setting screen is pressed, the activity UI 621 requests the activity logic component 622 to generate a job 512 for registering the macro 41. The activity logic component 622 generates the job 512 according to the request from the activity UI 621 and requests the request management component 64 to execute the job 512.

The request management component 64 requests the activity logic component 622 to perform a macro registration process according to the job 512.

(1-5) Storing Macro Conditions and Setting Macro Condition IDs

In response to the request from the request management component 64, the activity logic component 622 requests the filter/information logic components 652 corresponding to the filters constituting the activity of the macro 41 to register macro conditions (execution conditions).

When requested, each of the filter/information logic components 652 in turn requests the data management component 66 to register macro conditions, i.e., the execution conditions stored in the RAM, of the corresponding filter in the macro body information 412 of the macro 41.

The data management component 66 stores the macro conditions, for example, in the secondary storage unit 13, and manages the stored macro conditions. When storing the macro conditions, the data management component 66 generates a macro condition ID (condition identification information) for identifying the macro conditions of the filter and sends the macro condition ID to the corresponding one of the filter/information logic components 652.

Each of the filter/information logic components 652 sends the macro condition ID to the activity logic component 622, and the activity logic component 622 sends the macro condition ID to the request definition logic component 632.

When all of the filter/information logic components 652 complete registration of macro conditions and macro condition IDs, the activity logic component 622 requests the data management component 66 to register macro conditions, i.e., the execution conditions stored in the RAM, of the activity in the macro body information 412, receives a macro condition ID identifying the macro conditions of the activity from the data management component 66, and sends the macro condition ID to the request definition logic component 632.

(1-6) Registering Macro

The activity logic component 622 requests the request definition logic component 632 to register the macro 41.

When requested, the request definition logic component 632 sets the macro condition IDs received from the filter/information logic components 652 and the activity logic component 622 in the macro header information 411 and sends the macro header information 411 to the data management component 66.

Based on the macro header information 411 and the macro body information 412 generated as described above, the data management component 66 stores (registers) the macro 41, for example, in the secondary storage unit 13. Also, after storing the macro 41, the data management component 66 sends the macro ID of the macro 41 to the request definition logic component 632.

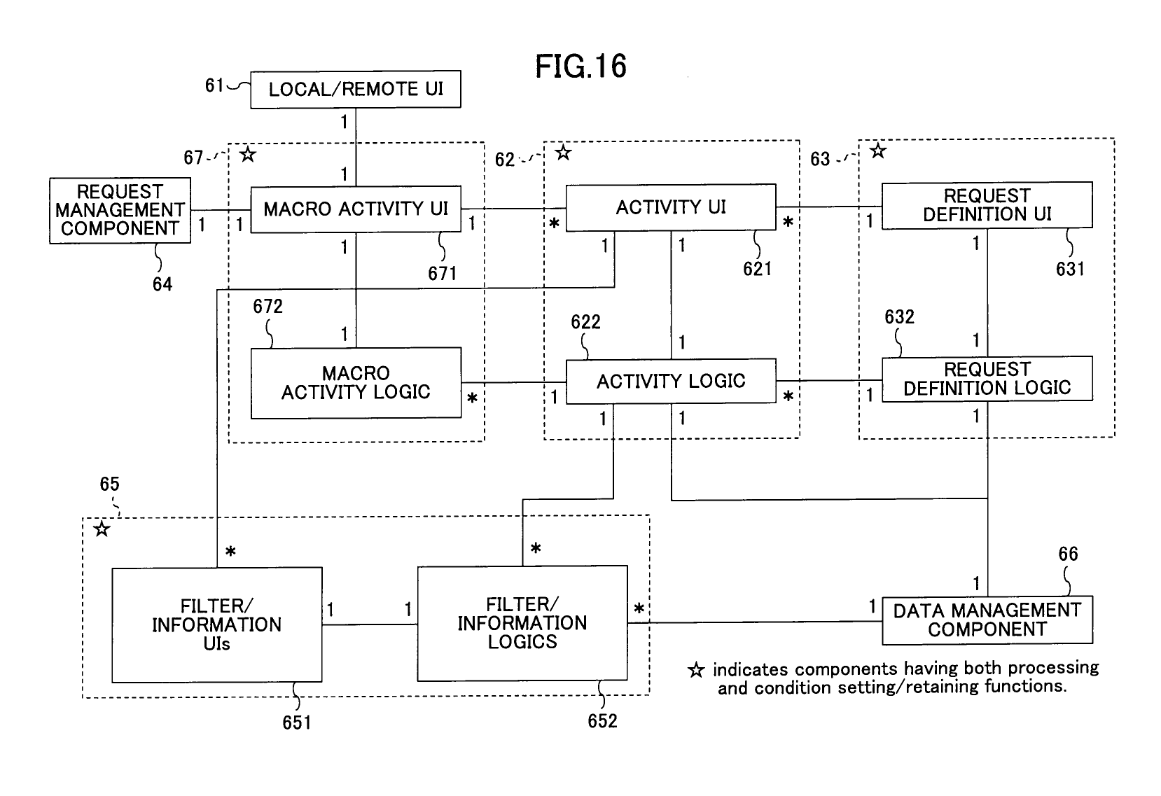

FIG. 16 is a drawing illustrating components involved in a macro retrieval process according to an embodiment of the present invention.

Components involved in a macro retrieval process includes the local/remote UI 61, the activity-related components 62, the request-definition-related components 63, the request management component 64, the filter/information-related components 65, the data management component 66, and macro-activity-related components 67. The activity-related components 62 include the activity UI 621 and the activity logic component 622 for each activity. The request-definition-related components 63 include the request definition UI 631 and the request definition logic component 632. The filter/information-related components 65 include the filter/information UIs 651 and the filter/information logic components 652. The macro-activity-related components 67 include a macro activity UI 671 and a macro activity logic component 672. Each component in the activity-related components 62, the request-definition-related components 63, the filter/information-related components 65, and the macro-activity-related components 67 has a structure as shown in FIG. 14.

Operations of the above components and relationships between them are described below using an exemplary macro retrieval process (steps 2-1 through 2-6).

(2-1) Displaying Macro List Screen

When a user presses the Macro button on the application selection screen 31 shown in FIG. 13 to request a macro list screen, the request is sent to the local/remote UI 61. When receiving the request, the local/remote UI 61 in turn requests the macro activity UI 671 to generate a next screen (user interface). The macro activity UI 671 generates a macro list screen, like the macro list screen 33 shown in FIG. 13, for selecting a macro to be retrieved, and displays the macro list screen on the display unit 19. More specifically, the macro activity UI 671 requests the request definition UI 631 to generate parts (or constituent elements) such as macro keys of the macro list screen and generates the macro list screen from the parts generated by the request definition UI 631.

(2-2) Receiving Macro Retrieval Request

When the user selects a macro and presses the Display button on the macro list screen, the macro ID of the selected macro is sent to the macro activity UI 671. Then, the macro activity UI 671 sends the macro ID to the macro activity logic component 672 and requests the macro activity logic component 672 to generate a job 512 for retrieving the selected macro. The macro activity logic component 672 generates the job 512 according to the request from the macro activity UI 671 and requests the request management component 64 to execute the job 512.

The request management component 64 requests the macro activity logic component 672 to perform a macro retrieval process according to the job 512.

(2-3) Obtaining Macro Header Information

The macro activity logic component 672 requests the request definition logic component 632 to obtain the macro header information 411 of the macro based on the macro ID. The macro activity logic component 672 thereby obtains the macro header information 411 and sends the obtained macro header information 411 to the macro activity UI 671.

Based on the macro header information 414, the macro activity UI 671 requests the activity UI 621 of the corresponding activity and the filter/information UIs 651 of filters constituting the activity to generate an activity screen (macro condition display screen) showing execution conditions (or macro conditions) of the activity and filters.

The activity UI 621 and the filter/information UIs 651 generate an activity screen including labels corresponding to the execution conditions of the activity and filters, and display the generated activity screen on the display unit 19.

(2-4) Analyzing Macro Configuration Information

The macro activity UI 671 analyses the macro configuration information 414 in the macro header information 411 to obtain information (e.g. activity name, filter names, and macro condition IDs) on the activity and the filters constituting the macro. Based on the obtained information, the macro activity UI 671 requests the macro activity logic component 672 to retrieve the macro conditions of the macro, which macro conditions are managed by the data management component 66.

The macro activity logic component 672 in turn requests the activity logic component 622 to retrieve the macro conditions.

(2-5) Retrieving Macro Conditions

When requested, the activity logic component 622 obtains the macro conditions of the activity from the data management component 66 based on the macro condition ID received from the macro activity logic component 672. The activity logic component 622 sends the obtained macro conditions to the activity UI 621, and the activity UI 621 causes the local/remote UI 61 to display the macro conditions as the execution conditions of the activity in the activity screen on the display unit 19. The activity logic component 622 also requests the filter/information logic components 652 corresponding to the constituent filters to retrieve the macro conditions of the filters.

When requested, the filter/information logic components 652 obtain the macro conditions of the filters from the data management component 66 based on the macro condition IDs received from the activity logic component 622. The filter/information logic components 652 send the obtained macro conditions to the filter/information UIs 651, and the filter/information UIs 651 cause the local/remote UI 61 to display the macro conditions as the execution conditions of the filters in the activity screen on the display unit 19.

(2-6) Executing Macro

When the user presses an Execute button on the activity screen, like the copy activity screen 33a or the fax activity screen 33b shown in FIG. 13, a macro execution request is sent to the local/remote UI 61.

### <Hardware Configuration of Information Processing Device>

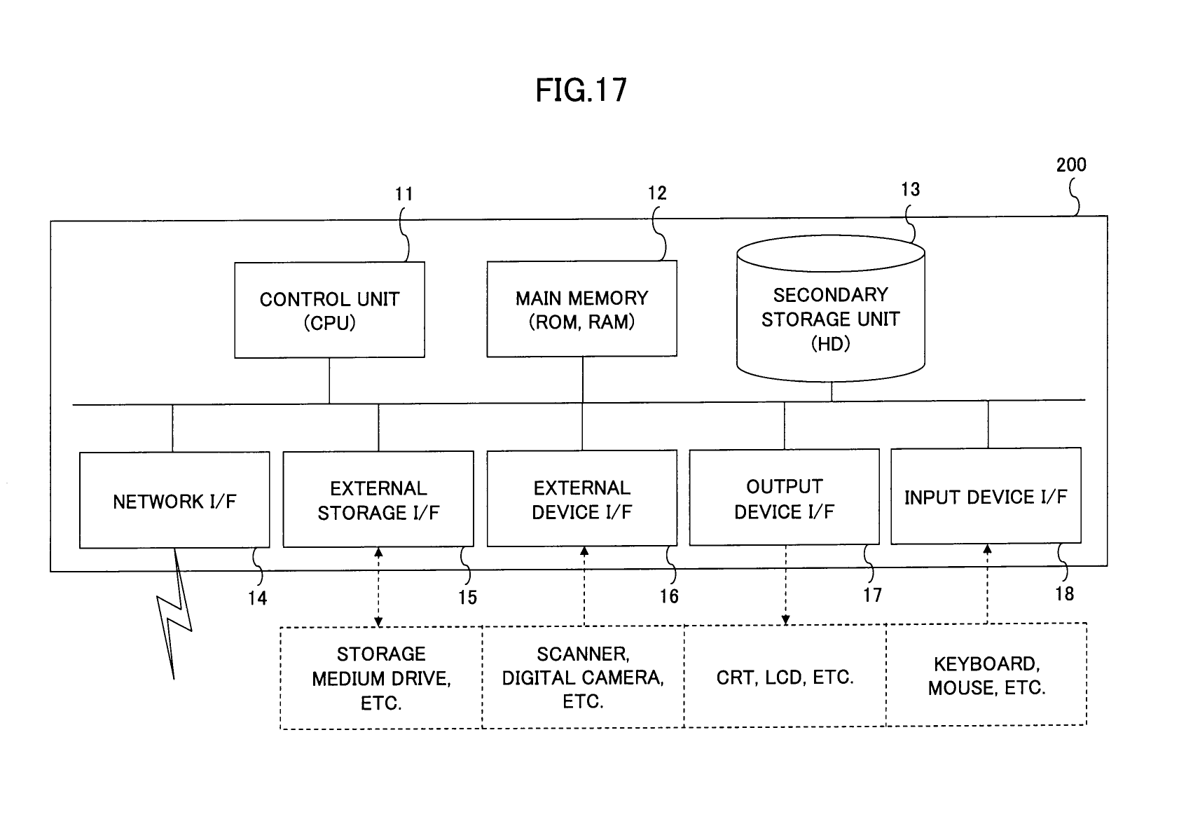

FIG. 17 is a block diagram illustrating a hardware configuration of an information processing device 200 according to an embodiment of the present invention.

As shown in FIG. 17, the information processing device 200 includes a control unit 11, a main memory 12, a secondary storage unit 13, a network I/F 14, an external storage I/F 15, an external device I/F 16, an output device I/F 17, and an input device I/F 18. In FIG. 17, the same reference numbers are used for parts corresponding to those of the image processing apparatus 100 shown in FIG. 1. Here, descriptions of the corresponding parts are omitted, and only descriptions of different parts are provided.

The output device I/F 17 interfaces the information processing device 200 and an output device (e.g. a cathode ray tube (CRT) display or a liquid crystal display (LCD)) connected via a data transmission line such as a cable.

The input device I/F 18 interfaces the image processing apparatus 200 and an input device (e.g. a keyboard or a mouse) connected via a data transmission line such as a USB.

The information processing device 200 provides its functions by executing programs stored in the main memory 12 and the secondary storage unit 13 and thereby controlling its constituent hardware units. The information processing device 200 is different from the image processing apparatus 100 in terms of its input and output facilities and the types of routine tasks it can perform. However, they are substantially the same in that they process information by executing programs with the control unit 11 and thereby controlling other constituent units. In other words, the information processing device 200 and the image processing apparatus 100 are substantially the same in that they allow a user to easily create a macro incorporating a new (unknown) function or filter and to efficiently perform a routine task by executing the macro.

### <Functional Units Involved in Macro Registration Process>

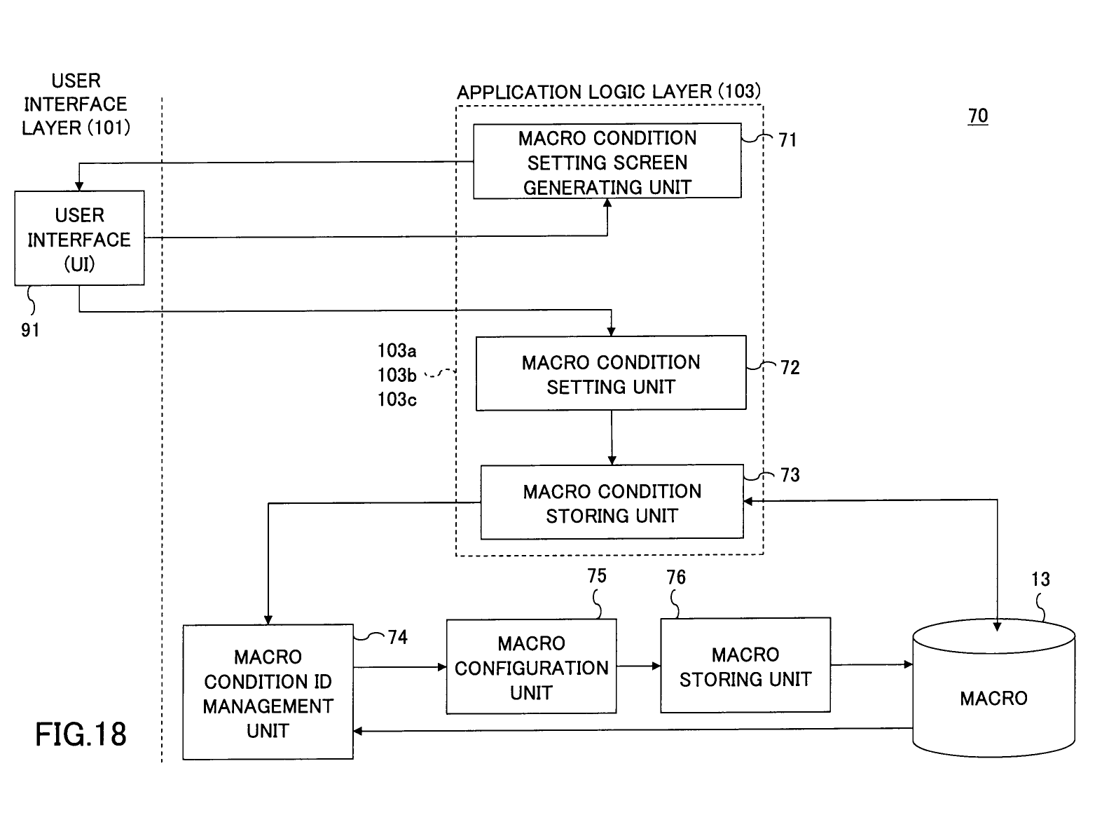

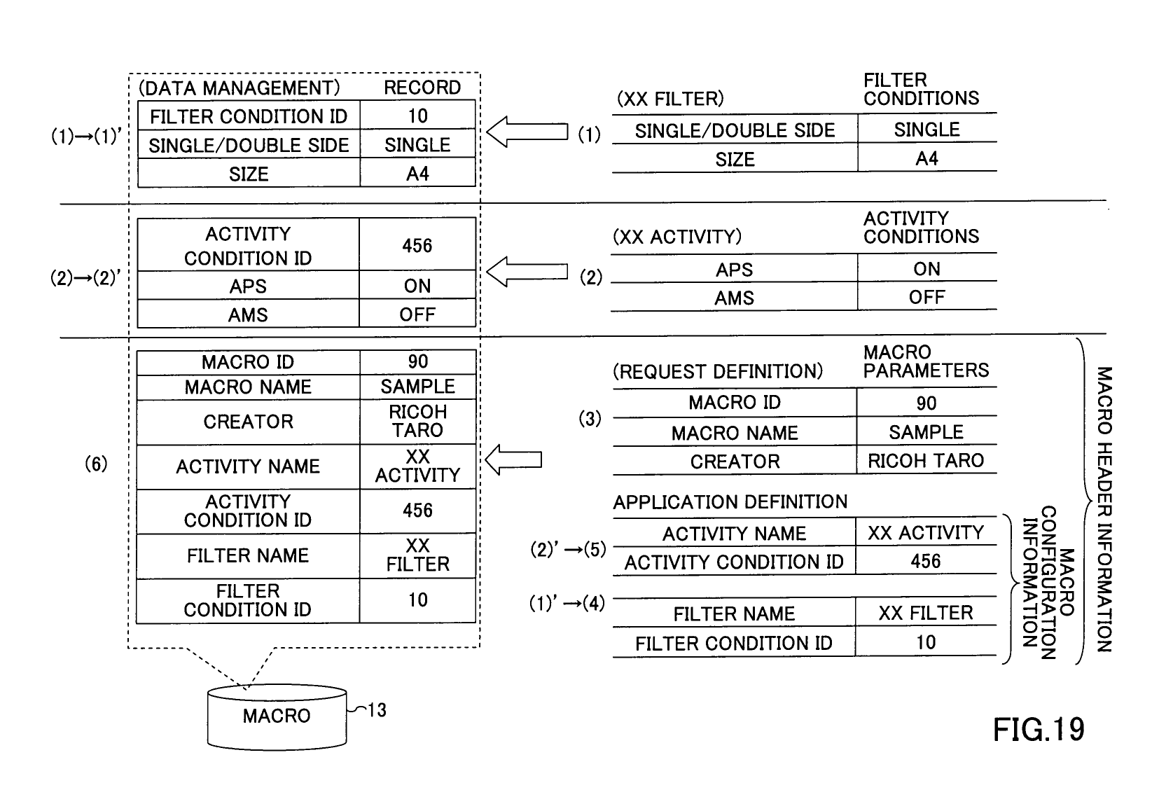

Functional units of the information processing device 200 involved in a macro registration process are described below with reference to FIGS. 18 and 19.

FIG. 18 is a block diagram illustrating functional units involved in a macro registration process according to an embodiment of the present invention.

As shown in FIG. 18, in this embodiment, a macro registration unit 70 performs a macro registration process.

The macro registration unit 70 includes macro condition setting screen generating units 71, macro condition setting units 72, macro condition storing units 73, a macro condition ID management unit 74, a macro configuration unit 75, and a macro storing unit 76.

Reference numbers 103a, 103b, and 103c in FIG. 18 indicate an input filter, a processing filter, and an output filter, respectively. In this embodiment, the input filter 103a, the processing filter 103b, and the output filter 103c may also be called a data input unit, a data processing unit, and a data output unit, respectively.

The macro condition setting screen generating units 71 generate an activity setting screen (macro condition setting screen), like the copy activity setting screen 31a or the multi-activity setting screen 31b shown in FIG. 7, for entering execution conditions of an activity, a data input unit(s), a data processing unit(s), and a data output unit(s), and displays the activity setting screen as a user interface 91 (here, the user interface 91 may represent multiple types of screens) on the display unit 19. In this embodiment, an activity represents a work process in a routine task, and data input, data processing, and data output units represent sub-processes in the work process.

The macro condition setting screen generating units 71 generate parts of the user interface 91 based on a list of execution conditions settable, and generate the user interface 91 from the parts. The execution conditions settable differ depending on the type of macro, a single-activity macro or a multi-activity macro, and depending on the type of activity. Therefore, the number and types of parts necessary for the user interface 91 differ depending on the type of macro and activity.

Each of the macro condition setting screen generating units 71 is incorporated in the corresponding one of the activity, the data input unit, the data processing unit, and the data output unit. The macro condition setting screen generating units 71 of the data input, data processing, and data output units constituting an activity generate corresponding parts (for setting their respective execution conditions) of the user interface 91, and send the generated parts to the macro condition setting screen generating unit 71 of the activity. The macro condition setting screen generating unit 71 of the activity receives the parts and generates the user interface 91 from the received parts.

The macro condition setting screen generating units 71 correspond to the local/remote UI 61, the activity UI 621, and the request definition UI 631 shown in FIG. 15.

The macro condition setting units 72 set parameters, i.e., macro conditions of the activity and the data input, data processing, and data output units based on their execution conditions.

The execution conditions of the activity and the data input, data processing, and data output units entered on the user interface 91 generated by the macro condition setting screen generating units 71 are stored in a RAM.

When the Register button on the macro parameter setting screen 32 as shown in FIG. 8 is pressed, the macro condition setting units 72 set macro conditions in the macro body information 412 of the macro 41 based on the execution conditions stored in the RAM.

FIG. 19 is a drawing illustrating how information items of a macro are structured.

The macro condition setting units 72 set the macro conditions of the activity and the data input, data processing, and data output units as exemplified in FIG. 19 based on the execution conditions stored in the RAM. In FIG. 19, (1) indicates macro conditions (filter conditions) of a filter (data input, data processing, or data output unit) and (2) indicates macro conditions (activity conditions) of an activity.

Each of the macro condition setting units 72 is incorporated in the corresponding one of the activity, the data input unit, the data processing unit, and the data output unit. In other words, each of the macro condition setting units 72 sets macro conditions of the corresponding one of the activity, the data input unit, the data processing unit, and the data output unit.

The macro condition setting units 72 correspond to the activity logic component 622 and the filter/information logic components 652 shown in FIG. 15.

Then, the macro condition storing units 73 store the macro conditions of the activity and the data input, data processing, and data output units, for example, in the secondary storage unit 13 of the information processing device 200.

For example, as shown in FIG. 19, the macro condition storing units 73 write the macro conditions (such as the filter conditions (1) and the activity conditions (2)) set by the macro condition setting units 72 in the macro body information 412 of the macro 41 as records (indicated by (1)′ and (2)′). Also, when writing the macro conditions, the macro condition storing units 73 generate macro condition IDs (condition identification information), i.e., an activity condition ID and filter condition IDs, identifying the macro conditions of the activity and the data input, data processing, and data output units, and write the macro condition IDs in the corresponding records of the macro body information 412.

Each of the macro condition storing units 73 is incorporated in the corresponding one of the activity, the data input unit, the data processing unit, and the data output unit. In other words, each of the macro condition storing units 73 stores macro conditions of the corresponding one of the activity, the data input unit, the data processing unit, and the data output unit in the secondary storage unit 13. The macro condition storing unit 73 of the activity stores the macro conditions of the activity after the macro condition storing units 73 of the data input, data processing, and data output units store their macro conditions and macro condition IDs.

The macro condition storing units 73 correspond to the activity logic component 622, the filter/information logic components 652, and the data management component 66 shown in FIG. 15.

The macro condition ID management unit 74 manages macro condition IDs (condition identification information) generated by the macro condition storing units 73.

The macro condition ID management unit 74 correlates the macro condition IDs, which are generated by the macro condition storing units 73, with the names of the activity, the data input unit, the data processing unit, and the data output unit. For example, as shown in “application definition” in FIG. 19, the macro condition ID management unit 74 correlates a filter name and a filter condition ID ((4) in FIG. 19) and correlates an activity name and an activity condition ID ((5) in FIG. 19). Thus, the macro condition ID management unit 74 generates the macro configuration information 414 constituting a part of the macro header information 411 of the macro 41.

The macro condition ID management unit 74 corresponds to the request definition logic component 632 shown in FIG. 15.

The macro configuration unit 75 generates the macro header information 411 of a macro to be registered.

When requested by the macro condition ID management unit 74, the macro configuration unit 75 generates the macro header information 411 based on the macro configuration information 414 generated by the macro condition ID management unit 74 and macro parameters entered on the macro parameter setting screen 32. For example, as shown in FIG. 19, the macro configuration unit 75 generates the macro header information 411 (6) based on the macro parameters (3) including a macro ID, a macro name, and a creator and on the macro configuration information 414 (application definition (4) and (5)). Thus, the macro configuration unit 75 correlates the macro configuration information 414 with the macro parameters that identify a macro.

The macro configuration unit 75 corresponds to the request definition logic component 632 shown in FIG. 15.

When requested by the macro condition ID management unit 74, the macro storing unit 76 stores the macro header information 411 generated by the macro configuration unit 75, for example, in the secondary storage unit 13 of the information processing device 200. For example, the macro storing unit 76 writes the macro header information 411 indicated by (3), (4), and (5) in FIG. 19 as a record (6) of the macro 41. The macro header information 411 and the macro body information 412 stored by the macro condition storing unit 73 together form the macro 41.

After storing the macro header information 411, the macro storing unit 76 sends the macro ID identifying the macro 41 to the macro condition ID management unit 76.

The macro storing unit 76 corresponds to the request definition logic component 632 and the data management component 66 shown in FIG. 15.

Thus, the macro condition setting screen generating units 71, the macro condition setting units 72, and the macro condition storing units 73 of the macro registration unit 70 of the information processing device 200 make it possible to set or change execution conditions of a new function/filter and an existing function/filter constituting a macro and to store the execution conditions as macro conditions.

Also, the macro condition ID management unit 74, the macro configuration unit 75, and the macro storing unit 76 of the macro registration unit 70 of the information processing device 200 make it possible to store macro condition IDs (condition identification information) identifying macro conditions, i.e., execution conditions of an activity and its constituent filters, in a macro and thereby to manage the macro conditions using the macro condition IDs. This configuration makes it possible for the information processing device 200 to configure a macro involving a new (unknown) function or filter.

In the information processing device 200, the macro condition setting screen generating unit 71, the macro condition setting unit 72, and the macro condition storing unit 73 of the macro registration unit 70 are incorporated in each of activities (functions) and filters. This configuration makes it possible to set execution conditions of a newly added (unknown) function or filter without adding new logic to or modifying existing logic of the information processing device 200.

### <Functional Units Involved in Macro Retrieval Process>

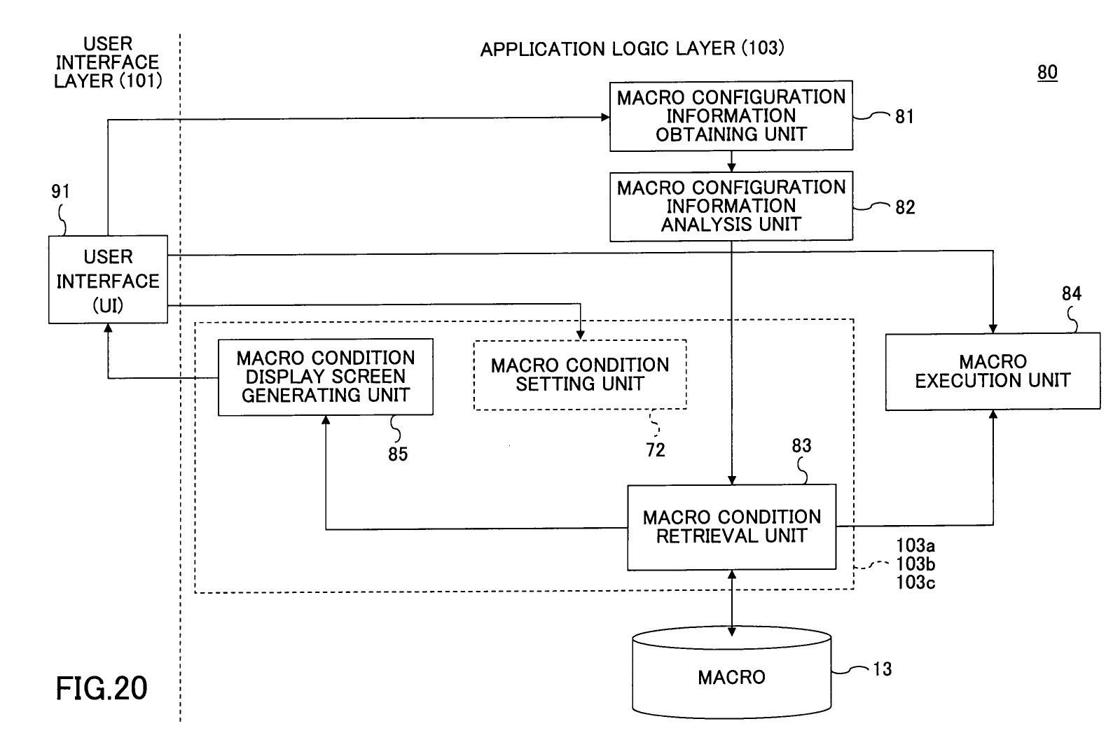

Functional units of the information processing device 200 involved in a macro retrieval process are described below with reference to FIG. 20.

FIG. 20 is a block diagram illustrating functional units involved in a macro retrieval process according to an embodiment of the present invention.

As shown in FIG. 20, in this embodiment, a macro retrieval unit 80 performs a macro retrieval process.

The macro retrieval unit 80 includes a macro configuration information obtaining unit 81, a macro configuration information analysis unit 82, macro condition retrieval units 83, a macro execution unit 84, and macro condition display screen generating units 85.

The macro configuration information obtaining unit 81 obtains the macro configuration information 414 from a macro.

When a macro (e.g., macro 41) is selected and a Display button is pressed on a user interface 61, like the macro list screen 33 shown in FIG. 13, a macro retrieval request is sent together with the macro ID of the macro 41 to the macro configuration information obtaining unit 81. The macro configuration information obtaining unit 81 retrieves the macro header information 411 (indicated by (6) in FIG. 19) of the macro 41 stored in the secondary storage unit 13 based on the macro ID. The macro configuration information obtaining unit 81 obtains the macro configuration information 414 (indicated by (4) and (5) in FIG. 19) from the retrieved macro header information 411.

The macro configuration information obtaining unit 81 corresponds to the macro activity UI 671 and the macro activity logic component 672 shown in FIG. 16.

Then, the macro configuration information analysis unit 82 analyzes the obtained macro configuration information 414 and extracts the macro condition IDs (condition identification information) from the macro configuration information 414.

More specifically, the macro configuration information analysis unit 82 analyzes the macro configuration information 414 obtained by the macro configuration information obtaining unit 81 and extracts the activity condition ID and the filter condition IDs of the activity and filters (data input, data processing, and data output units) constituting the macro 41.

The macro configuration information analysis unit 82 corresponds to the macro activity UI 671, the macro activity logic component 672, the activity logic component 622, and the filter/information logic components 652 shown in FIG. 16.

The macro condition retrieval units 83 retrieve macro conditions of the activity and the data input, data processing, and data output units from the secondary storage unit 13 based on the macro condition IDs extracted by the macro configuration information analysis unit 82. For example, the macro condition retrieval units 83 retrieve the macro conditions from the macro body information 412 (indicated by (1)′ and (2)′ in FIG. 19) of the macro 41 stored in the secondary storage unit 13 based on the activity condition ID (“456” in the macro configuration information 414 (5) in FIG. 19) and the filter condition ID (“10” in the macro configuration information 414 (4) in FIG. 19).

Each of the macro condition retrieval units 83 is incorporated in the corresponding one of the activity, the data input unit, the data processing unit, and the data output unit. In other words, each of the macro condition retrieval units 83 retrieves macro conditions of the corresponding one of the activity, the data input unit, the data processing unit, and the data output unit from the secondary storage unit 13. The macro condition retrieval unit 83 of the activity retrieves the macro conditions of the activity after the macro condition retrieval units 83 of the data input, data processing, and data output units retrieve their macro conditions.

The macro condition retrieval units 83 correspond to the activity logic component 622 and the filter/information logic components 652 shown in FIG. 16.

The macro execution unit 84 executes a macro according to the macro conditions of the activity, the data input unit, the data processing unit, and the data output unit retrieved by the macro condition retrieval units 83. When the user presses an Execute button on an activity screen displayed as the user interface 91, such as the copy activity screen 33a or the fax activity screen 33b shown in FIG. 13, a macro execution request is sent to the macro execution unit 84, and the macro execution unit 84 executes the corresponding macro.

The macro condition display screen generating units 85 generate an activity screen (macro condition display screen), like the copy activity screen 33a or the fax activity screen 33b shown in FIG. 13, for displaying and modifying the macro conditions (execution conditions) of a macro and executing the macro, and display the activity screen as the user interface 91 on the display unit 19. The macro condition display screen generating units 85 generate parts of the user interface 91 based on the macro conditions of the activity, the data input unit, the data processing unit, and the data output unit retrieved by the macro condition retrieval unit 83, and generate the user interface 91 from the generated parts.

Each of the macro condition display screen generating units 85 is incorporated in the corresponding one of the activity, the data input unit, the data processing unit, and the data output unit. The macro condition display screen generating units 85 of the data input, data processing, and data output units constituting an activity generate corresponding parts (for displaying their respective macro conditions) of the user interface 91, and send the generated parts to the macro condition display screen generating unit 85 of the activity. The macro condition display screen generating unit 85 of the activity receives the parts and generates the user interface 91 from the received parts.

The macro condition display screen generating units 85 also generate labels indicating the activity, the data input unit, the data processing unit, and the data output unit based on the names of them obtained by the macro configuration information analysis unit 82 from the macro configuration information 414 before generating the parts of the user interface 91. This configuration makes it possible to display the macro conditions together with the corresponding labels on the user interface 91.

The macro condition display screen generating units 85 correspond to the local/remote UI 61, the activity UI 621, and the filter/information UIs 651 shown in FIG. 16.

Thus, the macro configuration information obtaining unit 81, the macro configuration information analysis unit 82, the macro condition retrieval units 83, and the macro execution unit 84 of the macro retrieval unit 80 of the information processing device 200 make it possible to obtain the macro configuration information 414 in a macro, to extract macro condition IDs (condition identification information) from the macro configuration information 414, to retrieve macro conditions of an activity and filters constituting the macro based on the macro condition IDs, and to execute the macro according to the retrieved macro conditions. This configuration makes it possible for the information processing apparatus 200 to retrieve and execute a macro involving a new (unknown) function or filter.

In the information processing device 200, the macro condition retrieval unit 83 and the macro condition display screen generating unit 85 of the macro retrieval unit 80 are incorporated in each of activities (functions) and filters. This configuration makes it possible to retrieve execution conditions of a newly added activity or filter without adding new logic to or modifying existing logic of the information processing device 200.

Embodiments of the present invention make it possible to flexibly add new functions and filters to an information processing device and to create and execute a macro involving those new functions and filters.

<Macro Registration and Retrieval Processes>

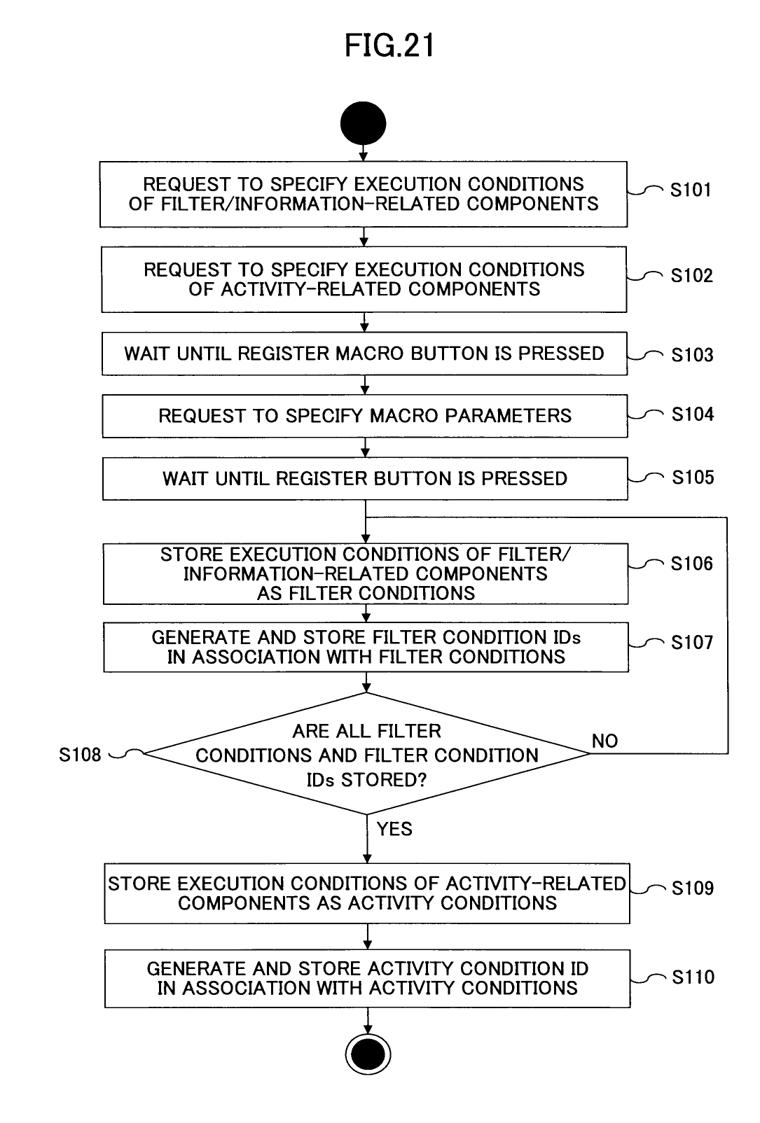

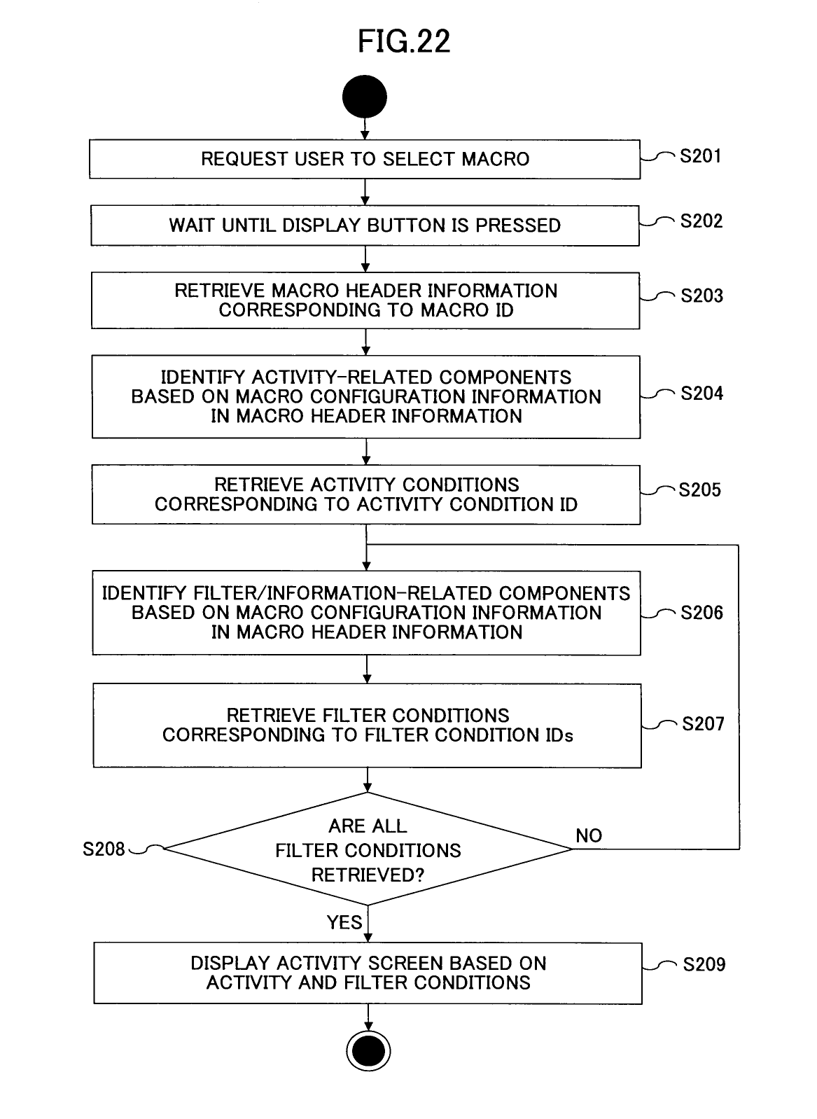

Exemplary macro registration and retrieval processes are described below with reference to FIGS. 21 and 22.

FIG. 21 is a flowchart showing an exemplary macro registration process according to an embodiment of the present invention.

The information processing apparatus 200 causes the local/remote UI 61 to display an activity setting screen (macro condition setting screen), like the copy activity setting screen 31a or the multi-activity setting screen 31b shown in FIG. 7, on the display unit 19, and thereby requests the user to specify execution conditions of the filter/information-related components 65 and the activity-related components 62 constituting a macro (i.e., to set execution conditions of an activity, an input filter, a processing filter, and an output filter) (S101 and S102).

The information processing device 200 waits until the Register Macro button on the activity setting screen is pressed (S103).

When the Register Macro button is pressed, the information processing device 200 causes the local/remote UI 61 to display a macro parameter setting screen, like the macro parameter setting screen 32 shown in FIG. 8, on the display unit 19 to request the user to specify a macro ID, a macro name, and a creator of the macro (S104) The information processing device 200 waits until the Register button on the macro parameter setting screen is pressed (S105).

When the Register button is pressed, the information processing device 200 stores the execution conditions of the filter/information-related components 65 specified in step S101 in the secondary storage unit 13 as macro conditions (filter conditions 415) (writes the execution conditions as records in the macro body information 412) (S106).

When storing the filter conditions 415 of the filter/information-related components 65, the information processing device 200 generates macro condition IDs (filter condition IDs) identifying the filter conditions 415 and stores the filter condition IDs in association with the corresponding filter conditions 415 (S107).

The information processing device 200 determines whether the filter conditions 415 and the filter condition IDs of all of the filter/information-related components 65 constituting the activity are stored (S108).

If the filter conditions 415 and the filter condition IDs of all of the filter/information-related components 65 have been stored (YES in step S108), the information processing device 200 stores the execution conditions of the activity-related components 62 specified in step S101 in the secondary storage unit 13 as macro conditions (activity conditions 413) (writes the execution conditions as records in the macro body information 412) (S109).

When storing the activity conditions 413 of the activity-related components 62, the information processing device 200 generates a macro condition ID (activity condition ID) identifying the activity conditions 413 and stores the activity condition ID in association with the activity conditions 413 (S110).

If the filter conditions 415 and the filter condition IDs of all of the filter/information-related components 65 have not been stored yet (NO in step S108), the information processing device 200 returns to step S106 and repeats the steps 106 and 107 until the filter conditions 415 and the filter condition IDs of all of the filter/information-related components 65 are stored.

FIG. 22 is a flowchart showing an exemplary macro retrieval process according to an embodiment of the present invention.

The information processing device 200 causes the local/remote UI 61 to display a macro list screen, like the macro list screen 33 shown in FIG. 13, on the display unit 19 to request the user to select a macro to be retrieved (S201).

The information processing device 200 waits until a Display button is pressed on the macro list screen (S202).

When the Display button is pressed, the information processing device 200 retrieves the macro header information 411 of the macro 41 corresponding to the macro ID of the selected macro from the secondary storage unit 13 (S203).

Based on the macro configuration information 414 in the macro header information 411, the information processing device 200 identifies the activity-related components 62 constituting the macro 41 (S204).

Then, the information processing device 200 retrieves the activity conditions 413 corresponding to the activity condition ID of the identified activity-related components 62 from the secondary storage unit 13 (S205).

Also, based on the macro configuration information 414 in the macro header information 411, the information processing device 200 identifies the filter/information-related components 65 constituting the activity (S206).

The information processing device 200 retrieves the filter conditions 415 corresponding to the filter condition IDs of the identified filter/information-related components 65 from the secondary storage unit 13 (S207).

Next, the information processing device 200 determines whether the filter conditions 415 of all of the identified filter/information-related components 65 are retrieved (S208).

If the filter conditions 415 of all of the identified filter/information-related components 65 have been retrieved (YES in step S208), the information processing device 200 causes the local/remote UI 61 to display an activity screen (macro condition display screen), like the copy activity screen 33a or the fax activity screen 33b shown in FIG. 13, on the display unit 19 based on the activity conditions 413 and the filter conditions 415 retrieved in the above steps (S209). When the Execute button is pressed on the activity screen, the information processing device 200 executes the macro 41 according to the activity conditions 413 and the filter conditions 415.

If the filter conditions 415 of all of the identified filter/information-related components 65 have not been retrieved yet (NO in step S208), the information processing device 200, returns to step S206 and repeats the steps 206 and 207 until the filter conditions 415 of all of the identified filter/information-related components 65 are retrieved.

### <Interactions Between Components in Macro Registration Process>

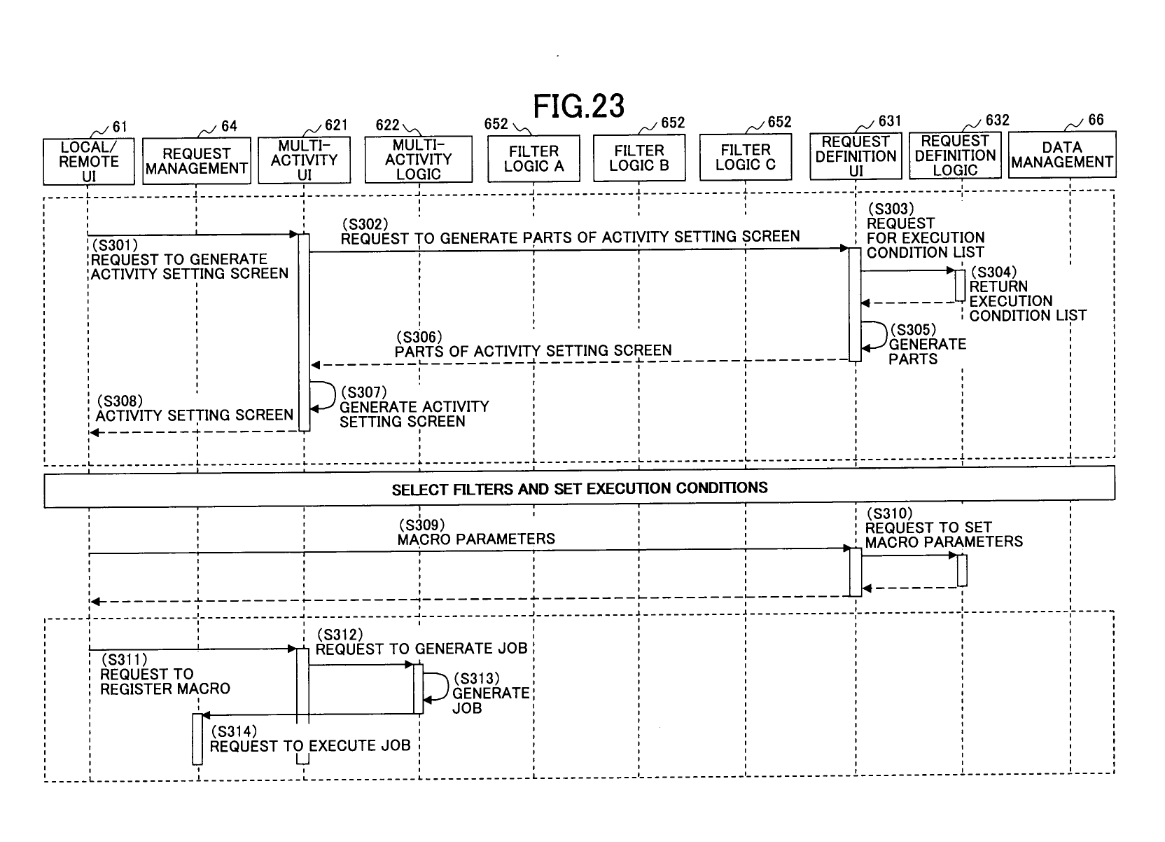

Interactions between components in exemplary macro registration processes are described below with reference to FIGS. 23 through 26.

FIG. 23 is a sequence chart showing interactions between components in a process of registering a multi-activity macro.

(1-1) Receiving Macro Registration Request

When a user presses a Multi-Activity button on the application selection screen 31 shown in FIG. 7, a multi-activity macro registration request is sent to the local/remote UI 61. When receiving the multi-activity macro registration request, the local/remote UI 61 requests the multi-activity UI 621 to generate a next screen (S301). The multi-activity UI 621 generates an activity setting screen (macro condition setting screen), like the multi-activity setting screen 31b shown in FIG. 7, for selecting filters that constitute a multi-activity and for entering execution conditions of the activity and the constituent filters according to the request from the local/remote UI 61, and displays the generated activity setting screen on the display unit 19.

More specifically, the multi-activity UI 621 requests the request definition UI 631 to generate parts (or constituent elements) of the activity setting screen (S302).

The request definition UI 631 requests the request definition logic component 632 to obtain a list of execution conditions settable for the activity and the constituent filters (S303). The request definition logic component 632 obtains and returns the list of execution conditions settable to the request definition UI 631 (S304). Then, the request definition UI 631 generates parts (e.g. labels) of the activity setting screen based on the list of execution conditions (S305), and returns the generated parts to the multi-activity UI 621 (S306).

The multi-activity UI 621 generates the activity setting screen from the parts sent from the request definition UI 631 (S307) and causes the local/remote UI 61 to display the generated activity setting screen on the display unit 19 (S308).

(1-2) Setting Execution Conditions of Activity and Filters

When the user presses the Register Macro button on the activity setting screen after selecting filters for the activity and entering the execution conditions of the activity and filters, the multi-activity UI 621 receives the execution conditions and sends the received execution conditions to the multi-activity logic component 622 and the filter/information logic components 652.

The multi-activity logic component 622 stores execution conditions of the activity, which are sent from the multi-activity UI 621, in an area of a RAM reserved by itself. Each of the filter/information logic components 652 stores execution conditions of the corresponding filter, which are sent from the multi-activity UI 621, in an area of a RAM reserved by itself.

(1-3) Setting Macro Parameters

Meanwhile, when the Register Macro button is pressed on the activity setting screen generated by the multi-activity UI 621, the local/remote UI 61 generates a macro parameter setting screen, like the macro parameter setting screen 32 shown in FIG. 8, for entering macro parameters including a macro ID, a macro name, and a creator, and displays the generated macro parameter setting screen on the display unit 19. The local/remote UI 61 receives macro parameters entered on the macro parameter setting screen and sends the received macro parameters to the request definition UI 631 (S309).

Based on the macro parameters, the request definition UI 631 requests the request definition logic component 632 to set the macro ID, the macro name, and the creator in the macro header information 411 of the macro 41 (S310).

(1-4) Requesting Registration of Macro

When the Register button on the macro parameter setting screen is pressed, the local/remote UI 61 requests the multi-activity UI 621 to register the macro 41 (S311). The multi-activity UI 621 requests the multi-activity logic component 622 to generate a job 512 for registering the macro 41 (S312).

The multi-activity logic component 622 generates the job 512 according to the request from the multi-activity UI 621 (S313) and requests the request management component 64 to execute the job 512 (S314).

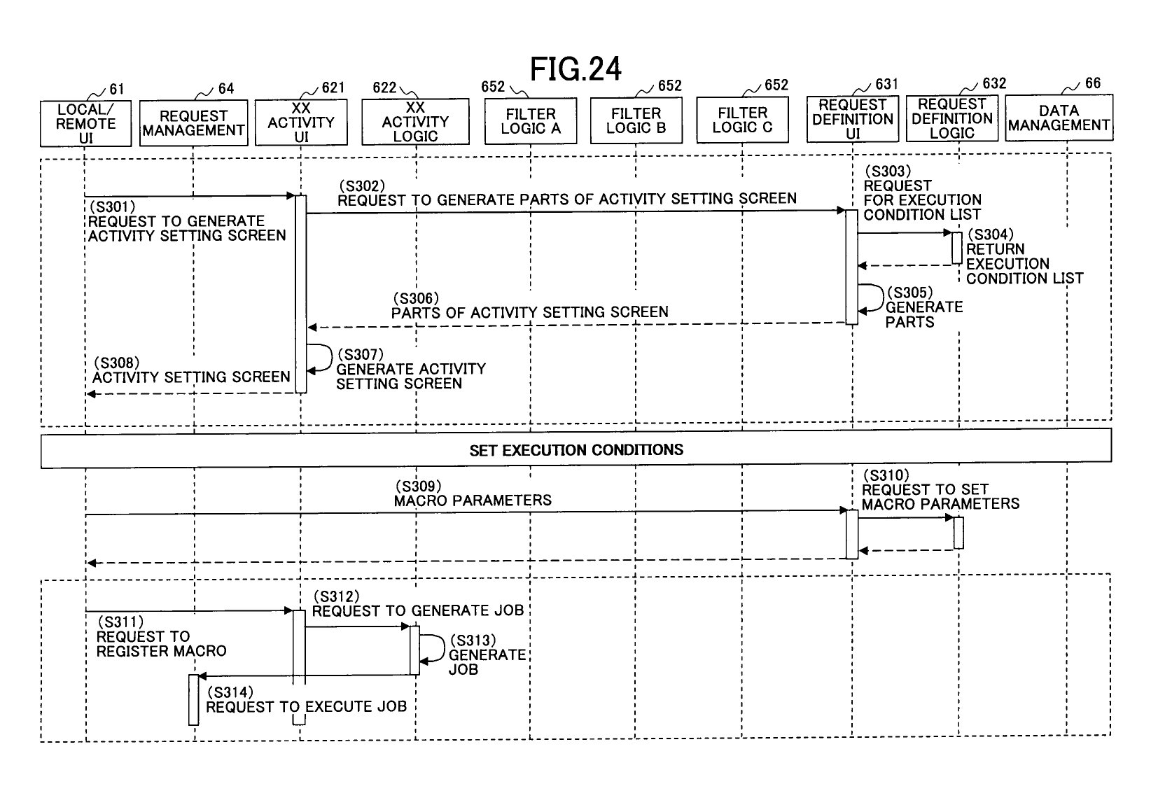

FIG. 24 is a sequence chart showing interactions between components in a process of registering a single-activity macro.

Here, differences between a multi-activity macro registration process shown in FIG. 23 and a single-activity macro registration process shown in FIG. 24 are mainly discussed.

In a single-activity registration process, when the user selects one of the functions (activities) by pressing the corresponding button on the application selection screen 31 shown in FIG. 7, an activity setting screen (macro condition setting screen), such as the copy activity setting screen 31a shown in FIG. 7, for setting execution conditions of the selected function (activity) and its constituent filters is displayed. In this case, unlike in the multi-activity registration process described above, the user does not have to select filters constituting the selected function. Also, since the activity setting screen displayed in a single-activity registration process is substantially the same as that used to configure a preset function, steps S302 through S306 (and even S307) may be omitted.

Other steps in the single-activity macro registration process shown in FIG. 24 are substantially the same as those in the multi-activity macro registration process shown in FIG. 23, and therefore descriptions of those steps are omitted here.

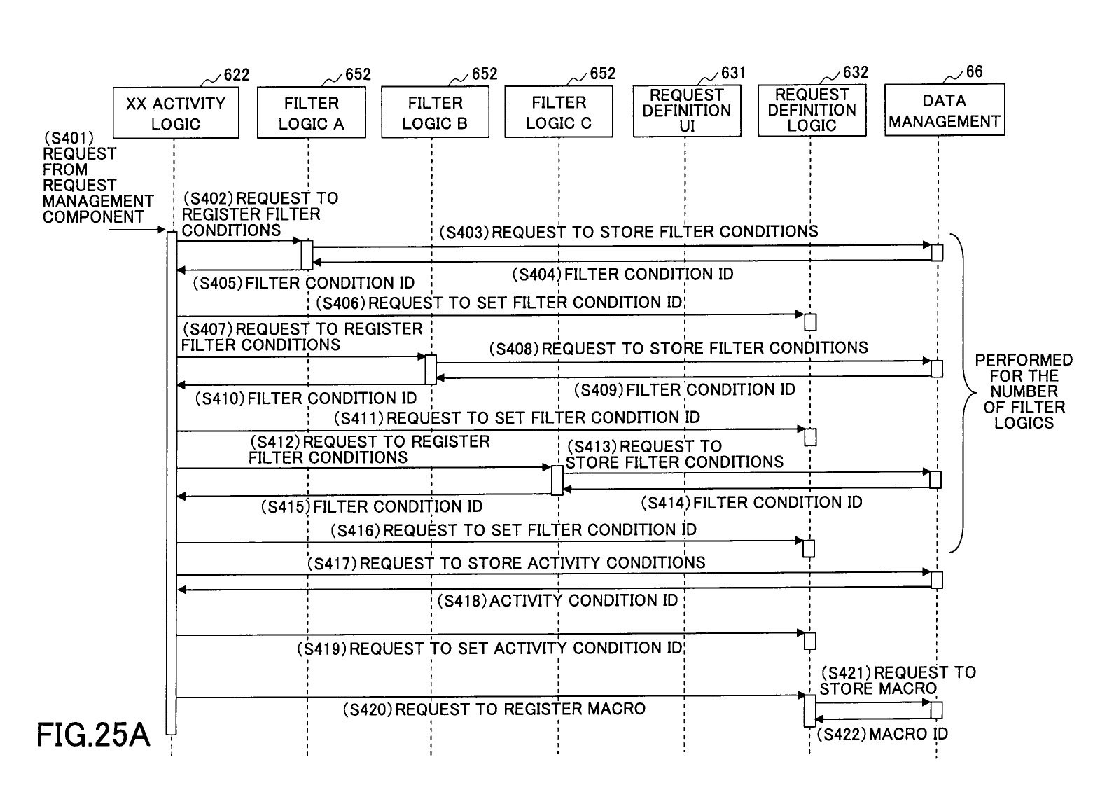

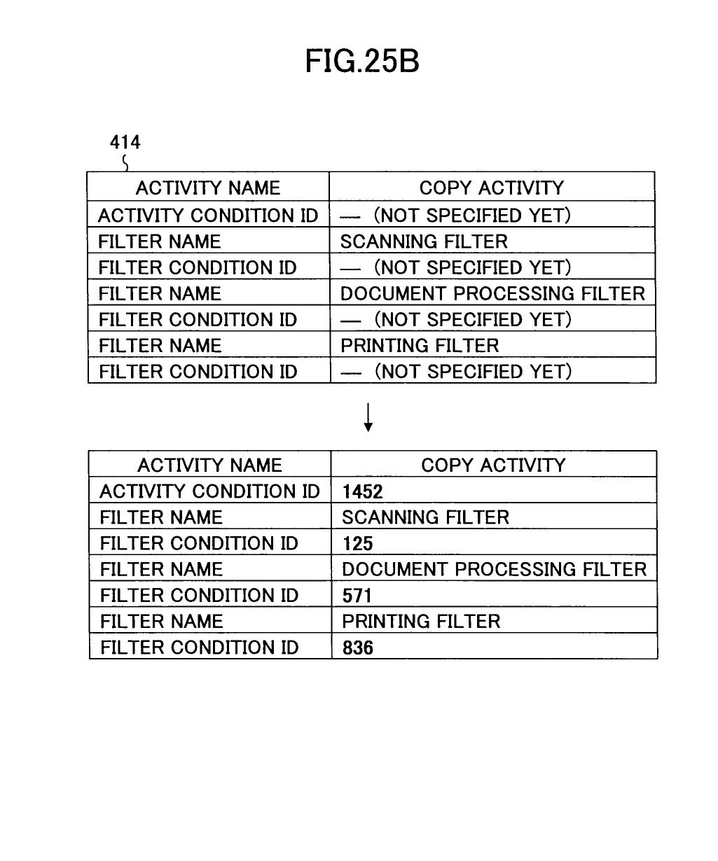

FIG. 25A is a sequence chart showing interactions between components in a process of registering a macro for document processing. It is assumed that steps shown in FIG. 25A are performed following the steps shown in FIG. 23 or 24.

(1-5) Storing Macro Conditions and Setting Macro Condition IDs

The request management component 64 requests the activity logic component 622 to perform a macro registration process according to the job 512 (S401).

In response to the request from the request management component 64, the activity logic component 622 requests each of the filter logic components 652 corresponding to the filters constituting the activity of the macro 41 to register macro conditions (filter conditions) (S402).

When requested, the filter logic component 652 requests the data management component 66 to register macro conditions, i.e., the execution conditions stored in the RAM, of the corresponding filter in the macro body information 412 of the macro 41. The data management component 66 stores the macro conditions, for example, in the secondary storage unit 13, and manages the stored macro conditions (S403). When storing the macro conditions, the data management component 66 generates a macro condition ID (filter condition ID) for identifying the macro conditions of the filter and sends the filter condition ID to the filter logic component 652 (S404).

The filter logic component 652 sends the filter condition ID to the activity logic component 622 (S405), and the activity logic component 622 requests the request definition logic component 632 to set the filter condition ID (S406).

Steps S402 through S406 are repeated for the number of the filter logic components 652 corresponding to filters constituting the activity (S407 through S416).

When all of the filter logic components 652 complete registration of macro conditions and filter condition IDs (after step S416), the activity logic component 622 requests the data management component 66 to store macro conditions (activity conditions), i.e., the execution conditions stored in the RAM, of the activity in the macro body information 412 (S417). The data management component 66 stores the macro conditions, for example, in the secondary storage unit 13, and manages the stored macro conditions. When storing the macro conditions, the data management component 66 generates a macro condition ID (activity condition ID) for identifying the macro conditions of the activity and sends the activity condition ID to the activity logic component 622 (S418).

The activity logic component 622 requests the request definition logic component 632 to set the activity condition ID (S419).

(1-6) Registering Macro

The activity logic component 622 requests the request definition logic component 632 to register the macro 41 (S420).

When requested, the request definition logic component 632 sets the macro condition IDs (the activity condition ID and the filter condition IDs) received from the activity logic component 622 and the filter logic components 652 in the macro header information 411 and sends the macro header information 411 to the data management component 66 (S421).

Based on the macro header information 411 and the macro body information 412 generated as described above, the data management component 66 stores (registers) the macro 41, for example, in the secondary storage unit 13. Also, after storing the macro 41, the data management component 66 sends the macro ID of the macro 41 to the request definition logic component 632 (S422).

FIG. 25B is a table showing exemplary macro configuration information 414. Through steps S406, S411, S416, and S419 shown in FIG. 25A, filter condition IDs and an activity condition ID are set in the macro configuration information 414 as shown in FIG. 25B (e.g. scanning filter condition ID: 125; processing filter condition ID: 571; printing filter condition ID: 836; and copy activity condition ID: 1452).

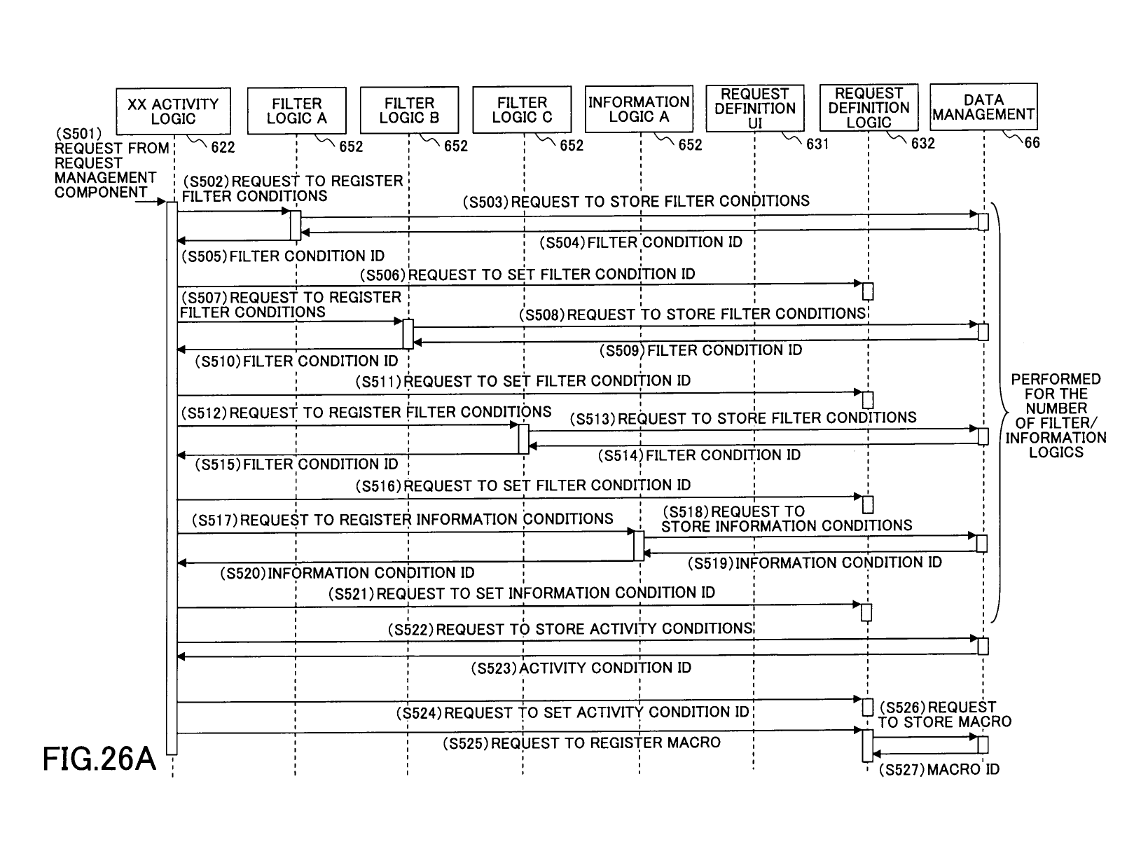

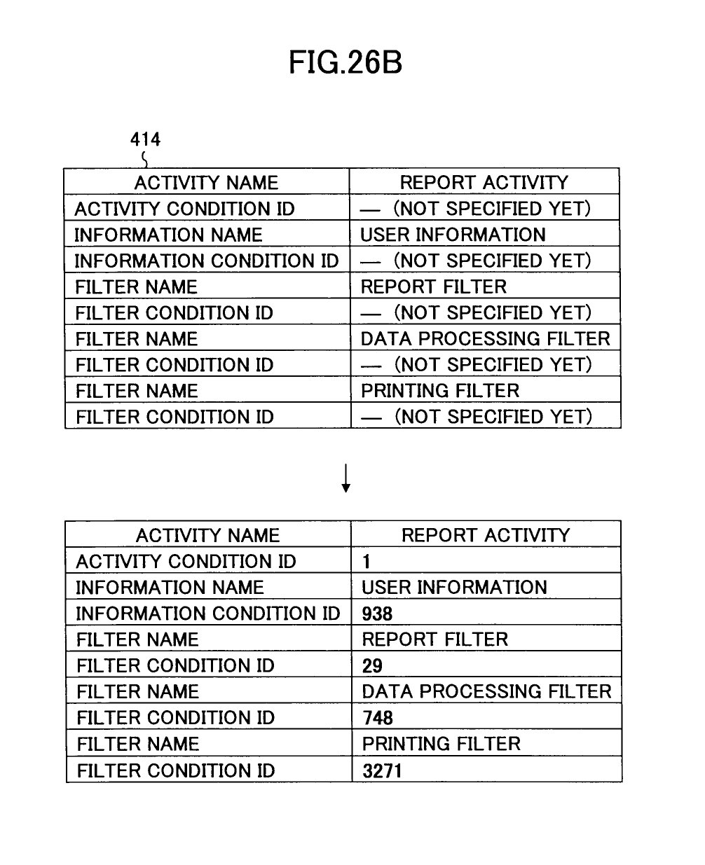

FIG. 26A is a sequence chart showing interactions between components in a process of registering a macro for data processing.

Here, differences between a process of registering a macro for document processing shown in FIG. 25A and a process of registering a macro for data processing shown in FIG. 26A are mainly discussed.

FIG. 26A shows a process of registering a macro for outputting a report on user information in the information processing apparatus 200. In the example shown in FIG. 26A, an information logic component (user information logic component) 652 is included in the activity of the macro in addition to the input, processing, and output filter logic components 652 (report filter, document processing filter, and printing filter shown in FIG. 26B). Therefore, in FIG. 26, steps of storing macro conditions (S517 through S521) are also provided for the user information logic component 652. Here, only steps S517 through S521 are described since other steps are substantially the same as the corresponding steps in FIG. 25A.

The activity logic component 622 requests the information logic component 652 corresponding to the information (user information) to be processed in the activity of the macro 41 to register macro conditions (information conditions) (S517).

When requested, the information logic component 652 requests the data management component 66 to register macro conditions (such as the range and items of user information to be processed) stored in the RAM in the macro body information 412 of the macro 41. The data management component 66 stores the macro conditions, for example, in the secondary storage unit 13, and manages the stored macro conditions (S518). When storing the macro conditions, the data management component 66 generates a macro condition ID (information condition ID) for identifying the macro conditions of the information logic component 652, and sends the information condition ID to the information logic component 652 (S519).

The information logic component 652 sends the information condition ID to the activity logic component 622 (S520), and the activity logic component 622 requests the request definition logic component 632 to set the information condition ID (S521).

Through the steps shown in FIG. 26A, filter/information condition IDs and an activity condition ID are set in the macro configuration information 414 as shown in FIG. 26B.

Thus, steps S517 through S521 are necessary in the process of registering a macro for data processing in addition to steps in the process of registering a macro for document processing.

### <Interactions Between Components in Macro Retrieval Process>

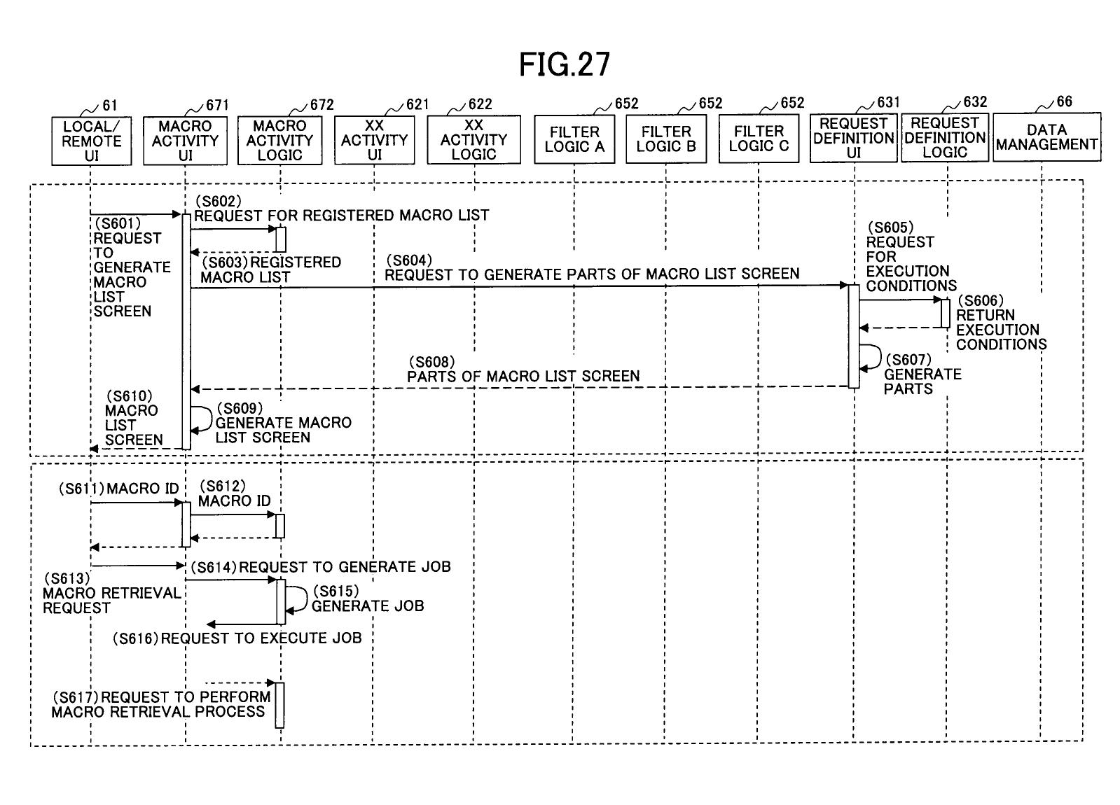

Interactions between components in an exemplary macro retrieval process are described below with reference to FIGS. 27 through 29.

FIG. 27 is a sequence chart showing interactions between components in a first part of an exemplary process of retrieving a macro.

(2-1) Displaying Macro List Screen

When a user presses the Macro button on the application selection screen 31 shown in FIG. 13 to request a macro list screen, the request is sent to the local/remote UI 61. When receiving the request, the local/remote UI 61 in turn requests the macro activity UI 671 to generate a next screen (S601).

The macro activity UI 671 generates a macro list screen, like the macro list screen 33 shown in FIG. 13, and displays the macro list screen on the display unit 19.

More specifically, the macro activity UI 671 requests the macro activity logic component 672 to obtain a list of executable registered macros (S602). The macro activity logic component 672 returns the list of executable registered macros to the macro activity UI 671 (S603).

Then, the macro activity UI 671 requests the request definition UI 631 to generate parts (or constituent elements) of the macro list screen based on the returned list of executable registered macros (S604).

The request definition UI 631 requests the request definition logic component 632 to obtain execution conditions of the macros in the list (S605). The request definition logic component 632 obtains and returns the execution conditions to the request definition UI 631 (S606). Then, the request definition UI 631 generates parts of the macro list screen based on the execution conditions (S607), and returns the generated parts to the macro activity UI 671 (S608).

The macro activity UI 671 generates the macro list screen from the parts sent from the request definition UI 631 (S609) and causes the local/remote UI 61 to display the generated macro list screen on the display unit 19 (S610).

(2-2) Receiving Macro Retrieval request

When the user selects a macro on the macro list screen, the macro ID of the selected macro is sent to the macro activity UI 671 (S611). Then, the macro activity UI 671 sends the macro ID to the macro activity logic component 672 (S612).

When the user presses a Display button on the macro list screen, a macro retrieval request is sent to the macro activity UI 671 (S613). The macro activity UI 671 requests the macro activity logic component 672 to generate a job 512 for retrieving the macro with the macro ID (S614).

The macro activity logic component 672 generates the job 512 according to the request from the macro activity UI 671 (S615) and requests the request management component 64 to execute the job 512 (S616).

The request management component 64 requests the macro activity logic component 672 to perform a macro retrieval process according to the job 512 (S617).

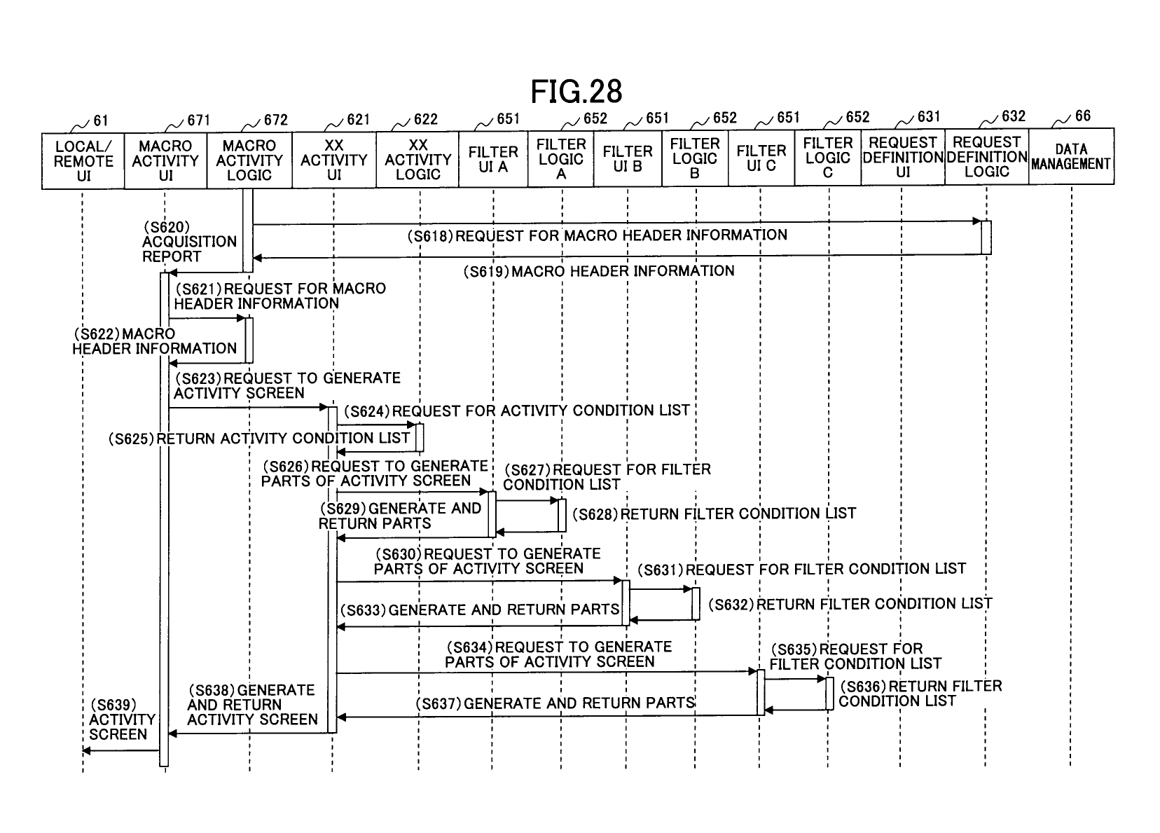

FIG. 28 is a sequence chart showing interactions between components in a second part of the exemplary process of retrieving a macro. The steps described below are performed following the steps shown in FIG. 27.

(2-3) Obtaining Macro Header Information

The macro activity logic component 672 requests the request definition logic component 632 to obtain the macro header information 411 of the macro based on the macro ID (S618). The request definition logic component 632 returns the macro header information 411 to the macro activity logic component 672 (S619), and the macro activity logic component 672 sends an acquisition report to the macro activity UI 671 (S620).

When receiving the acquisition report, the macro activity UI 671 obtains the macro header information 411 from the macro activity logic component 672 (S621 and S622). The macro activity UI 671 requests the activity UI 621 corresponding to the activity defined in the obtained macro header information 411 to generate an activity screen (macro condition display screen) for displaying execution conditions of the macro (S623).

The activity UI 621 requests the activity logic component 622 to obtain a list of macro conditions of the activity (a list of activity conditions) (S624). The activity logic component 622 returns the list of macro conditions to the activity UI 621 (S625).

The activity UI 621 requests each of the filter/information UIs 651 corresponding to filters constituting the activity to generate corresponding parts of the activity screen (S626). The filter/information UI 651 requests the filter/information logic component 652 to obtain a list of macro conditions of the corresponding filter (a list of filter conditions) (S627).

The filter/information logic component 652 returns the list of macro conditions of the filter to the filter/information UI 651 (S628). The filter/information UI 651 generates parts (e.g. labels) of the activity screen based on the returned list of macro conditions of the filter, and returns the generated parts to the activity UI 621 (S629).

Steps S626 through S629 are repeated for the number of the filter/information logic components 652 corresponding to filters constituting the activity (S630 through S637).

The activity UI 621 generates the activity screen from the list of macro conditions of the activity obtained in step S625 and the parts sent from the filter/information UIs 651, and sends the generated activity screen to the macro activity UI 671 (S638). The macro activity UI 671 causes the local/remote UI 61 to display the activity screen on the display unit 19 (S639)

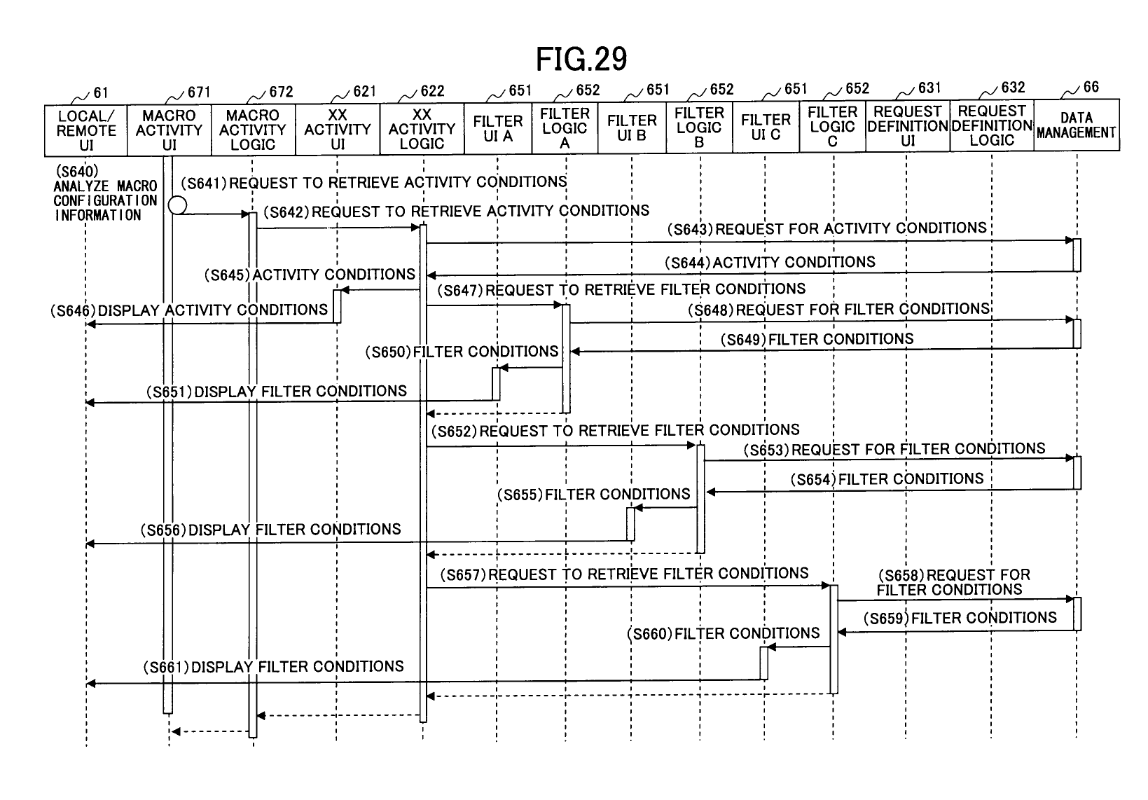

FIG. 29 is a sequence chart showing interactions between components in a third part of the exemplary process of retrieving a macro. The steps described below are performed following the steps shown in FIG. 28.

(2-4) Analyzing Macro Configuration Information

The macro activity UI 671 analyses the macro configuration information 414 in the macro header information 411 to obtain information on the activity and the filters constituting the macro (S640). Based on the obtained information, the macro activity UI 671 requests the macro activity logic component 672 to retrieve the macro conditions of the activity (activity conditions 413) which are managed by the data management component 66 (S641).

The macro activity logic component 672 in turn requests the corresponding activity logic component 622 to retrieve the activity conditions 413 (S642).

(2-5) Retrieving Macro Conditions

When requested, the activity logic component 622 obtains the activity conditions 413 from the data management component 66 based on the macro condition ID (activity condition ID) received from the macro activity logic component 672 (S643 and S644).

The activity logic component 622 sends the obtained activity conditions 413 to the activity UI 621 (S645), and the activity UI 621 causes the local/remote UI 61 to display the activity conditions 413 as the execution conditions of the activity in the activity screen on the display unit 19 (S646).

The activity logic component 622 also requests each of the filter/information logic components 652 corresponding to the constituent filters to retrieve the macro conditions of the corresponding filter (filter conditions 415) (s647).

When requested, the filter/information logic component 652 obtains the filter conditions 415 from the data management component 66 based on the macro condition ID received from the activity logic component 622 (S648 and S649). The filter/information logic component 652 sends the obtained filter conditions 415 to the filter/information UI 651 (S650), and the filter/information UI 651 causes the local/remote UI 61 to display the filter conditions 415 as the execution conditions of the filter in the activity screen on the display unit 19 (S651).

Steps S647 through S651 are repeated for the number of the filter/information logic components 652 corresponding to filters constituting the activity (S652 through S661).

(2-6) Executing Macro

When the user presses an Execute button on the activity screen, like the copy activity screen 33a or the fax activity screen 33b shown in FIG. 13, a macro execution request is sent to the local/remote UI 61.

### <Summary>

Thus, the macro registration unit 70 of the information processing device 200 makes it possible to set or change execution conditions of new functions/filters or existing functions/filters constituting a macro and to store the execution conditions as macro conditions.

Also, the macro registration unit 70 of the information processing device 200 makes it possible to store macro condition IDs (condition identification information) identifying macro conditions, i.e., execution conditions of an activity and its constituent filters, in a macro and thereby to manage the macro conditions using the macro condition IDs. This configuration makes it possible for the information processing device 200 to configure a macro involving a new (unknown) function or filter.

In the information processing device 200, the macro condition setting screen generating unit 71, the macro condition setting unit 72, and the macro condition storing unit 73 of the macro registration unit 70 are incorporated in each of activities (functions) and filters. This configuration makes it possible to set execution conditions of a newly added function or filter without adding new logic to or modifying existing logic of the information processing device 200.

The macro retrieval unit 80 of the information processing device 200 makes it possible to obtain the macro configuration information 414 in a macro, to extract macro condition IDs (condition identification information) from the macro configuration information 414, to retrieve macro conditions of an activity and filters constituting the macro based on the macro condition IDs, and to execute the macro according to the retrieved macro conditions. This configuration makes it possible for the information processing apparatus 200 to retrieve and execute a macro involving a new (unknown) function or filter.

In the information processing device 200, the macro condition retrieval unit 83 and the macro condition display screen generating unit 85 of the macro retrieval unit 80 is incorporated in each of activities (functions) and filters. This configuration makes it possible to retrieve execution conditions of a newly added activity or filter without adding new logic to or modifying existing logic of the information processing device 200.

Embodiments of the present invention make it possible to flexibly add new functions and filters to an information processing device and to create and execute a macro involving those new functions and filters.

The information processing device 200 is different from the image processing apparatus 100 in terms of its input and output facilities and the types of routine tasks it can perform. However, the information processing device 200 and the image processing apparatus 100 are substantially the same in that they allow a user to easily create a macro incorporating a new function or filter and to efficiently perform a routine task by executing the macro.

The macro registration unit 70 and the macro retrieval unit 80 of the information processing device 200 according to an embodiment of the present invention can be implemented by executing programs coded in a programming language that is supported by the platform of the information processing device 200 and those programs can be provided in a computer-readable storage medium.

An embodiment of the present invention provides an information processing device that makes it possible to create a macro involving a new (unknown) function or filter without changing the data structure of the macro.

In an information processing device according to an embodiment of the present information, each of functions and filters has a capability to generate a macro condition setting screen for setting execution conditions of itself. This configuration makes it possible to generate a macro condition setting screen of a newly added function or filter without adding new logic to or modifying existing logic of the information processing device.

In an information processing device according to an embodiment of the present information, it is possible to change macro conditions or execution conditions of a macro before executing the macro. This in turn makes it possible for a user to flexibly execute a macro.

In an information processing device according to an embodiment of the present information, it is possible to confirm macro conditions or execution conditions of a macro before executing the macro. This in turn prevents a user from executing a wrong macro.

Embodiments of the present invention provides an information processing device, an image processing apparatus, an information processing method, and a storage medium containing information processing program code that make it possible to flexibly add new functions and filters and to create and execute a macro involving those new functions and filters.

The present invention is not limited to the specifically disclosed embodiments, and variations and modifications may be made without departing from the scope of the present invention.

The present application is based on Japanese Priority Application No. 2007-006246, filed on Jan. 15, 2007, the entire contents of which are hereby incorporated herein by reference.

What is claimed is:

1. An information processing device for processing a macro defining at least execution conditions of a data input unit, a data processing unit, and a data output unit, the information processing device comprising:
a storage unit;
a user interface unit configured to receive a macro registration request and a macro retrieval request;
a macro registration unit configured to store the macro in the storage unit according to the macro registration request received by the user interface unit, the macro including macro condition IDs identifying macro conditions that are the execution conditions of the data input unit, the data processing unit, and the data output unit; and
a macro retrieval unit configured to retrieve the macro from the storage unit according to the macro retrieval request received by the user interface unit and to execute the retrieved macro.

2. The information processing device as claimed in claim 1, wherein the macro further defines execution conditions of an activity representing a work process performed by the data input unit, the data processing unit, and the data output unit and comprises macro configuration information including the macro condition IDs and names of the activity, the data input unit, the data processing unit, and the data output unit.

3. The information processing device as claimed in claim 2, wherein the macro registration unit includes
a macro condition setting screen generating unit configured to generate a macro condition setting screen for entering the execution conditions of the activity, the data input unit, the data processing unit, and the data output unit according to the macro registration request;
a macro condition setting unit configured to set the macro conditions of the activity, the data input unit, the data processing unit, and the data output unit based on the execution conditions entered on the macro condition setting screen; and
a macro condition storing unit configured to generate the macro condition IDs identifying the macro conditions set by the macro condition setting unit and to store the macro conditions together with the macro condition IDs in the storage unit.

4. The information processing device as claimed in claim 3, wherein the macro registration unit further includes
a macro condition ID management unit configured to manage the macro condition IDs generated by the macro condition storing unit by correlating the macro condition IDs with the names of the activity, the data input unit, the data processing unit, and the data output unit, and thereby to generate the macro configuration information;
a macro configuration unit configured to generate the macro from the generated macro configuration information; and
a macro storing unit configured to store the generated macro in the storage unit.

5. The information processing device as claimed in claim 3, wherein the macro condition setting screen generating unit is incorporated in each one of the activity, the data input unit, the data processing unit, and the data output unit, and is configured to generate corresponding parts of the macro condition setting screen.

6. The information processing device as claimed in claim 3, wherein the macro condition setting unit is incorporated in each one of the activity, the data input unit, the data processing unit, and the data output unit, and is configured to set the macro conditions of the each one of the activity, the data input unit, the data processing unit, and the data output unit.

7. The information processing device as claimed in claim 3, wherein the macro condition storing unit is incorporated in each one of the activity, the data input unit, the data processing unit, and the data output unit, and is configured to store the macro conditions of the each one of the activity, the data input unit, the data processing unit, and the data output unit together with the corresponding macro condition IDs in the storage unit.

8. The information processing device as claimed in claim 4, wherein the macro condition ID management unit is incorporated in each one of the activity, the data input unit, the data processing unit, and the data output unit, and is configured to manage the macro condition ID of the each one of the activity, the data input unit, the data processing unit, and the data output unit.

9. The information processing device as claimed in claim 2, wherein the macro retrieval unit includes
a macro configuration information obtaining unit configured to obtain the macro configuration information from the macro according to the macro retrieval request;
a macro configuration information analysis unit configured to analyze the obtained macro configuration information and thereby to extract the macro condition IDs from the macro configuration information;
a macro condition retrieval unit configured to retrieve the corresponding macro conditions from the storage unit based on the extracted macro condition IDs; and
a macro execution unit configured to execute the macro according to the retrieved macro conditions.

10. The information processing device as claimed in claim 9, wherein the macro condition retrieval unit is incorporated in each one of the activity, the data input unit, the data processing unit, and the data output unit, and is configured to retrieve the macro conditions of the each one of the activity, the data input unit, the data processing unit, and the data output unit from the storage unit.

11. The information processing device as claimed in claim 9, wherein the macro retrieval unit further includes a macro condition display screen generating unit configured to generate a macro condition display screen, based on the macro conditions retrieved by the macro condition retrieval unit, for confirming the macro conditions, changing the macro conditions, and requesting the macro execution unit to execute the macro.

12. The information processing device as claimed in claim 11, wherein
the macro condition display screen generating unit is incorporated in each one of the activity, the data input unit, the data processing unit, and the data output unit, and is configured to generate corresponding parts of the macro condition display screen.

13. An image processing apparatus including the information processing device as claimed in claim 1.

14. An information processing method in an information processing device for processing a macro defining at least execution conditions of a data input unit, a data processing unit, and a data output unit, the information processing method comprising:
a macro registration step of storing the macro in a storage unit of the information processing device according to a macro registration request, the macro including macro condition IDs identifying macro conditions that are the execution conditions of the data input unit, the data processing unit, and the data output unit; and
a macro retrieval step of retrieving the macro from the storage unit according to a macro retrieval request and executing the retrieved macro.

15. The information processing method as claimed in claim 14, wherein the macro further defines execution conditions of an activity representing a work process performed by the data input unit, the data processing unit, and the data output unit and comprises macro configuration information including the macro condition IDs and names of the activity, the data input unit, the data processing unit, and the data output unit.

16. The information processing method as claimed in claim 15, wherein the macro registration step includes
a macro condition setting screen generating step of generating a macro condition setting screen for entering the execution conditions of the activity, the data input unit, the data processing unit, and the data output unit according to the macro registration request;
a macro condition setting step of setting the macro conditions of the activity, the data input unit, the data processing unit, and the data output unit based on the execution conditions entered on the macro condition setting screen; and
a macro condition storing step of generating the macro condition IDs identifying the macro conditions set in the macro condition setting step and storing the macro conditions together with the macro condition IDs in the storage unit.

17. The information processing method as claimed in claim 16, wherein the macro registration step further includes
a macro condition ID management step of correlating the macro condition IDs generated in the macro condition storing step with the names of the activity, the data input unit, the data processing unit, and the data output unit, and thereby generating the macro configuration information;
a macro configuration step of generating the macro from the generated macro configuration information; and
a macro storing step of storing the generated macro in the storage unit.

18. The information processing method as claimed in claim 15, wherein the macro retrieval step includes
a macro configuration information obtaining step of obtaining the macro configuration information from the macro according to the macro retrieval request;
a macro configuration information analysis step of analyzing the obtained macro configuration information and thereby extracting the macro condition IDs from the macro configuration information;
a macro condition retrieval step of retrieving the corresponding macro conditions from the storage unit based on the extracted macro condition IDs; and
a macro execution step of executing the macro according to the retrieved macro conditions.

19. A storage medium having program code embodied therein for causing a computer to function as a macro registration unit and a macro retrieval unit of an information processing device for processing a macro defining at least execution conditions of a data input unit, a data processing unit, and a data output unit, wherein
the macro registration unit is configured to store the macro in a storage unit of the information processing device according to a macro registration request received by a user interface unit of the information processing device, the macro including macro condition IDs identifying macro conditions that are the execution conditions of the data input unit, the data processing unit, and the data output unit; and
the macro retrieval unit is configured to retrieve the macro stored in the storage unit according to a macro retrieval request received by the user interface unit and to execute the retrieved macro.

20. An information processing device for processing a macro defining at least execution conditions of a data input unit, a data processing unit, and a data output unit, the information processing device comprising:
a storage unit;
request receiving means for receiving a macro registration request and a macro retrieval request;
means for storing the macro in the storage unit according to the macro registration request received by the request receiving means, the macro including macro condition IDs identifying macro conditions that are the execution conditions of the data input unit, the data processing unit, and the data output unit; and
means for retrieving the macro from the storage unit according to the macro retrieval request received by the request receiving means and for executing the retrieved macro.
